(19) United States
(12) Patent Application Publication
(10) Pub. No.: US 2016/0257177 A1
(43) Pub. Date: Sep. 8, 2016

(54) BUMP STOPPER AND MANUFACTURING METHOD THEREFOR

(71) Applicant: FUKOKU CO., LTD., Saitama (JP)

(72) Inventors: Kenji NOBUSUE, Saitami-shi (JP); Tatsuo YAMADA, Saitama (JP)

(73) Assignee: FUKOKU CO., LTD., Saitama (JP)

(21) Appl. No.: 15/158,138

(22) Filed: May 18, 2016

Related U.S. Application Data
(63) Continuation of application No. 14/254,755, filed on Apr. 16, 2014, now abandoned.
Application No. 14/254,755 is a division of application No. 12/737,234, filed on Mar. 10, 2011, now abandoned.

(30) Foreign Application Priority Data
Jun. 26, 2008 (JP) 2008-167226
Feb. 4, 2009 (JP) 2009-023266
Mar. 9, 2009 (JP) 2009-055021

(51) Int. Cl. B60G 11/22; B60G 15/06

(52) U.S. Cl. CPC B60G 11/22; B60G 15/06; B60G 2206/81012; B60G 2202/143; B60G 2206/42; B60G 2206/82

(57) ABSTRACT

Disclosed are a bump stopper and a manufacturing method therefor which can maintain the shock-absorbing characteristics and durability performance constantly for a prolonged period of time regardless of the temperature or humidity of the usage environment, which can maintain a constant dimensional precision for a finished product, which is excellent in material yield rate and manufacturing efficiency, and which is low-cost, lightweight, recyclable, and ecological. A bump stopper (1) is provided in the vicinity of a rod of a shock absorber to elastically limit the stroke of the shock absorber at the time of the contraction thereof and to absorb the shock generated at that time. The bump stopper includes a hollow cylindrical bellows part (11) which extends along a stroke direction S of the shock absorber. The bellows part is formed by thinning thermoplastic resin and is constructed such that first parts (12) which are bulged outward and second parts (13) which are recessed inward are provided alternately and repeatedly in the stroke direction S.

### CROSS-REFERENCE TO RELATED APPLICATIONS

This application is a continuation application of co-pending U.S. application Ser. No. 14/254,755, filed Apr. 16, 2014, which is a divisional application of U.S. application Ser. No. 12/737,234, filed Mar. 10, 2011, which is a nationalization of PCT/JP2009/061783 filed Jun. 26, 2009, and published in Japanese, which has priorities of Japanese Application No. 2008-167226 filed Jun. 26, 2008, Japanese Application No. 2009-023266 filed Feb. 4, 2009, and Japanese Application No. 2009-055021 filed Mar. 9, 2009, and hereby claims the priorities thereof to which it is entitled, and the disclosure of which is incorporated by reference as if fully set forth herein.

### TECHNICAL FIELD

The present invention relates to, for example, a piston rod of a shock absorber which absorbs the shock from the road surface, a bump stopper which is provided in the vicinity of the piston rod to elastically limit the stroke (retraction amount) of the shock absorber at the time of the contraction thereof and to absorb the shock generated at the time of striking bottom (bump touch), and a manufacturing method therefor.

In addition, although the bump stopper may be called, for example, a bump rubber, a jounce bumper, or the like, the bump stopper will be used as a generic term for all of these.

### BACKGROUND ART

Conventionally, various shock absorbers are used for the suspension for use in, for example, vehicles, such as an automobile, in order to achieve riding comfort or operation (travel) stability during traveling. For example, as shown in Patent Citation 1, the shock absorber includes a cylindrical body portion, and a piston rod supported on the body portion so as to be capable of advancing and retreating, and is adapted such that, when a load (for example, a force including shock, vibration, or the like from the road surface) has acted on the suspension during traveling, the piston rod extends and retracts (strokes) relative to the body portion according to the magnitude of the load, so that the load which has acted is absorbed and the movement of the suspension is attenuated (shock-absorbed).

In this case, depending on the magnitude of the load which has acted on the suspension, the stroke of the piston rod may reach the allowable limit (full contraction of the shock absorber called striking bottom(bump touch)), and shock may be repeatedly generated at that time. Then, there is a concern that it may become difficult to maintain a constant riding comfort or operation (travel) stability during traveling. Thus, various kinds of bump stoppers for absorbing the shock generated at the time of striking bottom (bump touch) are applied to the shock absorber.

An example of a conventional bump stopper is shown in FIG. 13, and the bump stopper 2 is coaxially provided at a piston rod 6 of a shock absorber including a cylindrical body portion (cylinder body) 4 and the piston rod 6 supported so as to be capable of advancing and retreating (protruding and retracting) in the direction of the arrow S along the inside of the body portion 4. Such a bump stopper 2 is molded from, for example, urethane foam resin (reaction injection molding: RIM), and an insertion hole 2h through which the rod 6 of a shock absorber passes is formed at a central portion of the bump stopper so as to penetrate the urethane foam resin.

Additionally, one side of the bump stopper 2 is press-fitted into a cup 8 in a state where the insertion hole 2h has been externally fitted to the piston rod 6, and the cup 8 is fixed to an attachment fitting 10 which supports the piston rod 6 in a vibration-proof manner on the side of a vehicle body. Thereby, the bump stopper 2 is positioned and arranged between the arrangement fitting 10 and the shock absorber. In addition, urethane foam resin is, for example, thermosetting resin molded by combining an A liquid consisting mainly of polyether polyol, and a B liquid consisting mainly of polyisocyanate, and a foaming agent.

As another example, a bump stopper 2 shown in FIG. 14 is constructed to include a hollow cylindrical bellows part 204 and is adapted to be assembled to a shock absorber by fixing one end 202a (an upper end in FIG. 14) of the piston rod to a supporting member G (for example, a member which supports the piston rod 6 in a vibration-proof manner on the side of a vehicle body) in a state where the piston rod 6 has been inserted through the bellows part 204. In addition, annular recesses 204r which have a circular-arc cross-section are formed along the stroke direction S of the shock absorber (the stroke direction S of the piston rod 6) in the inner peripheral surface of the bellows part 204, and thereby, the bellows part 204 is constructed as an elastic body which is elastically expandable and contractible along the stroke direction S.

Such a bump stopper 2 is able to make a compressive elastic deformation due to elastic deformation of the urethane foam resin itself or collapsing of air bubbles mixed in the urethane foam resin, thereby absorbing a shock, when a load (for example, a force including shock, vibration, or the like from the road surface) has acted on the suspension and the stroke of the piston rod 6 reaches the allowable limit (full contraction of the shock absorber called striking bottom (bump touch)). Thereby, riding comfort or operation (travel) stability during traveling can be maintained constantly.

### RELATED ART DOCUMENT

### Patent Citation

Patent Citation 1: Japanese Unexamined Patent Application Publication No. 2006-281811

Patent Citation 2: Japanese Unexamined Patent Application Publication No. 2000-301923

### DISCLOSURE OF INVENTION

### Technical Problem

Since the above conventional bump stopper 2 is molded in its entirety by thickening urethane foam resin, not only does the weight of the entire bump stopper 2 increase by the amount thickened, but also more urethane-resin material is required during manufacturing. Therefore, manufacturing costs will rise.

Additionally, the above conventional bump stopper 2 is molded (reaction injection molding: RIM) by mixedly injecting the two liquids above, A liquid and B liquid, into mold tools and foaming the liquids simultaneously when causing a polymerization reaction (chemical reaction). For this reason, there is a certain limitation to shortening the molding cycle time required to produce a finished product. In other words, it is necessary for the molding cycle time to be lengthened. As a result, there is a certain limitation on improving the manufacturing efficiency of the bump stopper 2.

Moreover, since the above reaction injection molding (RIM) is apt to be influenced by the molding environment (for example, temperature or humidity), within the molding tools, it is difficult to maintain the dimensional precision of the bump stopper 2 serving as a finished product constantly.

Additionally, the above urethane foam resin has material characteristics of being inferior in durability in a low-temperature environment. For this reason, in a case where a vehicle using the bump stopper 2 made of urethane foam resin is used, for example, in a cold region, it may be difficult to constantly maintain the shock-absorbing characteristics of the bump stopper 2 for a prolonged period of time, and the bump stopper 2 may be damaged in a case where the vehicle is used at an extremely low temperature.

Moreover, the above urethane foam resin has material characteristics of being easily hydrolyzed and being inferior in water resistance. For this reason, in a case where a vehicle using the bump stopper 2 made of urethane foam resin is used, for example, in a humid area with a lot of rain, or in a case where the chassis of the vehicle is steam-washed, it may be difficult to constantly maintain the durability performance of the bump stopper 2 for a prolonged period of time.

Moreover, since the above urethane foam resin material cannot be reused (recycled), for example, a used bump stopper is obliged to be discarded as is, the material yield rate is bad, and a bump stopper for which the global environment (environmentalism: recycling of products which are produced commercially) is taken into consideration is not provided.

Additionally, in a case where a bump stopper is thinned and molded, this is preferable in respect of reduction in weight or the like. However, since the external diameter of a piston rod of a shock absorber to be inserted through the bump stopper and the internal diameter of the bump stopper are greatly different from each other, the separation distance between the outer peripheral surface of the piston rod and the inner peripheral surface of the bump stopper will increase.

For this reason, when the bump stopper makes a compressive elastic deformation, “wobbling” may occur in which the whole or a portion of the bump stopper inclines or deforms compressively in a direction deviated from the stroke direction (the direction of the axial center of the piston rod) of the shock absorber, and a portion of the bump stopper deviates in a transverse direction (radial direction). Then, there is a concern that the shock-absorbing characteristics in a desired stroke direction cannot be maintained, and improvements for this are desired.

Additionally, in order to improve the riding comfort of a vehicle, a bump stopper has recently been demanded which can absorb a shock gently by setting the stroke of a shock absorber to be large and effectively using the enlarged stroke.

In order to meet this demand, a shock can be gently absorbed by setting the overall length of the bump stopper to be long, thereby increasing the amount of stroke at the time of compressive deformation.

However, if the overall length of the bump stopper is increased, there is a concern that “wobbling” of the bump stopper may be promoted in the stroke direction of the shock absorber, and improvements for this are desirable.

Meanwhile, although it is typical that the conventional bump stopper 2 (bellows part 204) is molded (reaction injection molding: RIM) from urethane foam resin, the urethane foam resin has material characteristics which are inferior in durability or water resistance. Additionally, it is necessary to prevent the entrance of foreign matter, such as dust (for example, water, dust, or the like) from the insertion hole (not shown) of the piston rod 6 formed in the end surface of the cylinder body (body portion) 4 of the shock absorber. For this reason, as shown in FIG. 14, it is generally conventional that a dust cover 206 is mounted so as to cover the entire bump stopper 2 and the insertion hole of the piston rod 6 of the shock absorber simultaneously.

However, if the dust cover 206 is mounted, the mounting work for the dust cover 206 is required in addition to the attachment work of the bump stopper 2 and thereby, the number of parts increases. Therefore, there is a certain limitation to the simplification or cost lowering of assembly work. Additionally, the above dust cover 206 also has a problem that enlargement is readily caused from the necessity for covering the entire bump stopper 2 and the insertion hole of the piston rod 6 of the shock absorber simultaneously.

Thus, a bump stopper made of rubber in which a dust cover which covers an insertion hole of a piston rod of a shock absorber is integrated is suggested in Patent Citation 2. If a bump stopper 2 shown in FIG. 15 is described as an example, an annular dust cover 206 is integrally molded at a bellows part 204 of the bump stopper 2 so as to be suspended from the whole outer edge of the other end 202b (lower end of FIG. 15) of the bellows part. In such a bump stopper 2, the bump stopper 2 itself is made of rubber. Therefore, the bump stopper is excellent in water resistance compared to urethane foam resin, and a cover which covers the entire bump stopper in order to protect the bump stopper from rain water or the like becomes unnecessary. Additionally, since the dust cover 206 is integrated with the bump stopper 2, the following new problems occur although the bumper stopper is preferable in respect of the miniaturization of the cover, reduction in number of parts, and assembling workability.

First, in order to mold the dust cover 206 so as to be suspended integrally from the whole outer edge of the other end 202b of the bump stopper 2 (bellows part 204), a separate molding process for the dust cover 206 from the molding process of the bellows part 204 may be required. In this case, the thickness of the dust cover 206 is made smaller than the thickness of the bellows part 204. In order to mold the bump stopper 2 with this shape, mutually different molding processes (for example, thickness adjustment between the bellows part 204 and the dust cover 206, adjustment of molding time in each molding process, or the like) are required in the molding process of the bellows part 204 and the molding process of the dust cover 206. Then, since the molding process of the bump stopper 2 becomes complicated and effort and time required therefor are substantial, there is a certain limitation to improvements in the manufacturing efficiency of the bump stopper 2 (for example, shortening of manufacturing time or reduction in manufacturing costs).

The invention has been made in order to solve such problems, and the first object thereof is to provide a bump stopper and a manufacturing method therefor which can constantly maintain the shock-absorbing characteristics and durability performance for a prolonged period of time regardless of the temperature or humidity of the usage environment, which can maintain a constant dimensional precision for a finished product, which is excellent in material yield rate and manufacturing efficiency, and which is low-cost, lightweight, recyclable, and ecological.

Additionally, in addition to the first object, a second object of the invention is to provide a bump stopper and a manufacturing method therefor which can prevent wobbling with respect to a stroke direction of a shock absorber at the time of elastic deformation, thereby maintaining shock-absorbing characteristics in a desired stroke direction.

Moreover, in addition to the first object, a third object of the invention is to provide a bump stopper which can improve manufacturing efficiency, is excellent in water resistance, and can prevent entry of foreign matter, such as dust into a cylinder body, without providing a dust cover separately.

### Technical Solution

In order to solve the above first object, the invention provides a bump stopper provided in the vicinity of a piston rod of a shock absorber to elastically limit the stroke of the shock absorber at the time of the contraction thereof and to absorb the shock generated at that time. The bump stopper includes a hollow cylindrical bellows part which extends along the stroke direction of the shock absorber. The bellows part is molded by thinning thermoplastic resin and is constructed such that first parts which are bulged in a direction opposite to a central direction and second parts which are recessed in the central direction are provided alternately and repeatedly in the stroke direction.

In the invention, top portions of the first parts and top portions of the second parts may have outer peripheral surfaces and inner peripheral surfaces formed in the shape of a circular arc along the stroke direction.

In the invention, outer peripheral surfaces and inner peripheral surfaces of the second parts are formed in the shape of a circular arc along the stroke direction, and the radius of curvature of the outer peripheral surfaces of the first parts in the stroke direction is smaller than the radius of curvature of the outer peripheral surfaces of the second parts in the stroke direction. In addition, the inner peripheral surfaces of the first parts may be formed in the shape of a circular arc along the stroke direction.

In the invention, outer peripheral surfaces and inner peripheral surfaces of the first parts are formed in the shape of a circular arc along the stroke direction, and the radius of curvature of the outer peripheral surfaces of the second parts in the stroke direction is smaller than the radius of curvature of the outer peripheral surfaces of the first parts in the stroke direction. In addition, the inner peripheral surfaces of the second parts may be formed in the shape of a circular arc along the stroke direction.

In order to solve the above second object, the invention provides a bump stopper including a hollow cylindrical bellows part provided so as to be externally fitted to a piston rod of a shock absorber to elastically limit the stroke of the shock absorber at the time of the contraction thereof and to absorb the shock generated at that time. The bellows part is molded by thinning thermoplastic resin and is constructed such that first parts which are bulged in a direction opposite to a central direction and second parts which are recessed in the central direction are provided alternately and repeatedly in the stroke direction. The bump stopper includes an axial deviation regulating portion which regulates axial deviation of the bellows part with respect to the piston rod.

In the invention, the axial deviation regulating portion which regulates axial deviation of the bellows part with respect to the piston rod may be provided at an end located on the side of the shock absorber. In that case, the axial deviation regulating portion may be molded continuously and integrally with the bellows part, and the diameter thereof may be reduced in the central direction so as to come closer to the piston rod than the second parts.

Additionally, the axial deviation regulating portion may be provided at the bellows part. In that case, the axial deviation regulating portion may be molded continuously and integrally with the bellows part, and the diameter thereof may be reduced in the central direction so as to come closer to the piston rod than the second parts.

Moreover, in order to solve the above third object, the invention provides a bump stopper provided in a shock absorber to elastically limit the stroke of the shock absorber at the time of the contraction thereof and to absorb the shock generated at that time. The bump stopper includes a hollow cylindrical bellows part which is molded by thinning thermoplastic resin, extends along the stroke direction of the shock absorber and which is elastically expandable and contractible along the stroke direction, a first annular end provided at one end of the bellows part, and a second annular end provided at the other end of the bellows part. The first end is supported by a supporting member provided at the tip of the piston rod of the shock absorber, and the second end is supported by a cylinder body of the shock absorber.

In the invention, the bump stopper may be assembled between the supporting member and the cylinder body in a state where the first end is brought into pressure contact with the supporting member by the elastic force of the bellows part, and the second end is brought into pressure contact with the cylinder body by the elastic force of the bellows part.

Additionally, communication passages which enable outflow and inflow of air between the inside and outside of the bellows part when the bellows part expands and contracts along the stroke direction may be provided. In this case, the communication passages are provided in at least one of the first end and the second end. Additionally, the communication passages may have the structure in which entry of water into the inside of the bellows part is regulated.

Additionally, the invention is a manufacturing method of a bump stopper. The manufacturing method includes the steps: either setting mold tools having inner surfaces formed with an undulating shape along an external contour of the bellows part, at an outer periphery of a parison made of thermoplastic resin, or setting a parison made of thermoplastic resin, at inner surfaces of mold tools having the inner surfaces formed with an undulating shape along an external contour of the bellows part; and injecting a gas into the parison to swell the parison, to mold the bellows part. In addition, in the invention, the parison means that a preform is included.

### Advantageous Effects

According to the invention, it is possible to provide a bump stopper and a manufacturing method therefor which can constantly maintain the shock-absorbing characteristics and durability performance for a prolonged period of time regardless of the temperature or humidity of the usage environment, which can maintain a constant dimensional precision for a finished product, which is excellent in material yield rate and manufacturing efficiency, and which is low-cost, lightweight, recyclable, and ecological.

Additionally, it is possible to provide a bump stopper and a manufacturing method therefor which can improve manufacturing efficiency, is excellent in water resistance, and can prevent entry of foreign matter, such as dust into a cylinder body, without providing a dust cover separately.

Moreover, it is possible to provide a bump stopper and a manufacturing method therefor which can prevent wobbling with respect to a stroke direction of a shock absorber at the time of elastic deformation, thereby maintaining shock-absorbing characteristics in a desired stroke direction.

### BRIEF DESCRIPTION OF DRAWINGS

FIG. 1A is a schematic cross-sectional view showing a state where a bump stopper according to Embodiment 1 of the invention is used for a shock absorber.

FIG. 1B is a schematic side view showing a state where the bump stopper according to Embodiment 1 of the invention is used for a shock absorber.

FIG. 1C is a schematic cross-sectional view showing a first modification of the bump stopper according to Embodiment 1 of the invention.

FIG. 2A is a schematic cross-sectional view showing the process of manufacturing the bump stopper according to Embodiment 1 of the invention and showing the process of continuously forming a parison in a tubular shape at the inner surfaces of mold tools.

FIG. 2B is a schematic cross-sectional view showing the process of manufacturing the bump stopper according to Embodiment 1 of the invention and showing the process of injecting a gas into the parison and bringing the parison into close contact with the inner surfaces of the mold tools.

FIG. 2C is a schematic cross-sectional view showing the process of manufacturing the bump stopper according to Embodiment 1 of the invention and showing the process of removing the bump stopper from the mold tools.

FIG. 2D is a schematic cross-sectional view showing the process of manufacturing the bump stopper according to Embodiment 1 of the invention and showing the process of cutting a surplus portion from upper and lower ends of the bump stopper.

FIG. 3A is an explanatory view showing a test result evaluated for the effects of the bump stopper according to Embodiment 1 of the invention, in an initial state where the bump stopper 1 is not compressed.

FIG. 3B is an explanatory view showing a test result evaluated for the effects of the bump stopper according to Embodiment 1 of the invention, in a first state where the bump stopper has been gradually compressed.

FIG. 3C is an explanatory view showing a test result evaluated for the effects of the bump stopper according to Embodiment 1 of the invention, in a second state where the bump stopper has been further compressed.

FIG. 3D is an explanatory view showing a test result evaluated for the effects of the bump stopper according to Embodiment 1 of the invention, in a third state where the bump stopper has been most compressed.

FIG. 3E is an explanatory view showing a test result evaluated for the effects of the bump stopper according to Embodiment 1 of the invention, and a graph showing the compression-load characteristics of a conventional product (an existing product).

FIG. 4A is a schematic cross-sectional view showing a bump stopper according to Embodiment 2 of the invention and showing a state where the bump stopper is used for a shock absorber.

FIG. 4B is a schematic side view showing the bump stopper according to Embodiment 2 of the invention and showing a state where the bump stopper is used for a shock absorber.

FIG. 4C is a schematic cross-sectional view showing the bump stopper according to Embodiment 2 of the invention and showing a first modification of the bump stopper.

FIG. 5A is a schematic cross-sectional view showing the manufacturing process of the bump stopper according to Embodiment 2 of the invention and showing the process of continuously forming a parison in a tubular shape at the inner surfaces of mold tools.

FIG. 5B is a schematic cross-sectional view showing the process of manufacturing the bump stopper according to Embodiment 2 of the invention and showing the process of injecting a gas into the parison and bringing the parison into close contact with the inner surfaces of the mold tools.

FIG. 5C is a schematic cross-sectional view showing the process of manufacturing the bump stopper according to Embodiment 2 of the invention and showing the process of removing the bump stopper from the mold tools.

FIG. 5D is a schematic cross-sectional view showing the process of manufacturing the bump stopper according to Embodiment 2 of the invention and showing the process of cutting a surplus portion from upper and lower ends of the bump stopper.

FIG. 6A is a schematic cross-sectional view showing a bump stopper according to Embodiment 3 of the invention and showing a state where the bump stopper is used for a shock absorber.

FIG. 6B is a schematic side view showing the bump stopper according to Embodiment 3 of the invention and showing a state where the bump stopper is used for a shock absorber.

FIG. 6C is a schematic cross-sectional view showing the bump stopper according to Embodiment 3 of the invention and showing a second modification of the bump stopper.

FIG. 7A is an explanatory view showing a test result evaluated for the effects of the bump stoppers according to Embodiments 2 to 4 and Embodiment 5 of the invention, in an initial state where the bump stopper is not compressed.

FIG. 7B is an explanatory view showing a test result evaluated for the effects of the bump stoppers according to Embodiments 2 to 4 and Embodiment 5 of the invention, in a first state where the bump stopper has been gradually compressed.

FIG. 7C is an explanatory view showing a test result evaluated for the effects of the bump stoppers according to Embodiments 2 to 4 and Embodiment 5 of the invention, in a second state where the bump stopper has been further compressed.

FIG. 7D is an explanatory view showing a test result evaluated for the effects of the bump stoppers according to Embodiments 2 to 4 and Embodiment 5 of the invention, in a third state where the bump stopper has been most compressed.

FIG. 7E is an explanatory view showing a test result evaluated for the effects of the bump stoppers according to Embodiments 2 to 4 and Embodiment 5 of the invention, and a graph showing the compression-load characteristics of a conventional product (an existing product).

FIG. 8A is a cross-sectional view showing a state where a bump stopper according to Embodiment 6 of the invention is assembled to a shock absorber.

FIG. 8B is a cross-sectional view schematically showing the process of assembling the bump stopper according to Embodiment 6 of the invention to a shock absorber.

FIG. 8C is a cross-sectional view showing the construction of a shock absorber in the state before the bump stopper according to Embodiment 6 of the invention is assembled to the shock absorber.

FIG. 8D is a cross-sectional view showing the construction of the bump stopper in the state before the bump stopper according to Embodiment 6 of the invention is assembled to a shock absorber.

FIG. 9A is a schematic cross-sectional view showing the process of manufacturing the bump stopper according to Embodiment 6 of the invention and showing the process of pulling up a parison into mold tools.

FIG. 9B is a schematic cross-sectional view showing the process of manufacturing the bump stopper according to Embodiment 6 of the invention and showing the process of injecting air into the parison and bringing the parison into close contact with the inner surfaces of the mold tools.

FIG. 9C is a schematic cross-sectional view showing the process of manufacturing the bump stopper according to Embodiment 6 of the invention and showing the process of removing a molded product from the mold tools.

FIG. 9D is a schematic cross-sectional view showing the process of manufacturing the bump stopper according to Embodiment 6 of the invention and showing the process of cutting a surplus portion to finish a bump stopper.

FIG. 10A is a view showing a test result evaluated for the effects of the bump stopper according to Embodiment 6 of the invention, and schematically showing the bump stopper in an initial state where the bump stopper is not compressed and elastically deformed.

FIG. 10B is a view showing a test result evaluated for the effects of the bump stopper according to Embodiment 6 of the invention, and schematically showing the bump stopper in a first state where the bump stopper has been gradually compressed and elastically deformed from the initial state.

FIG. 10C is a view showing a test result evaluated for the effects of the bump stopper according to Embodiment 6 of the invention, and schematically showing the bump stopper in a second state where the bump stopper has been further compressed and elastically deformed from the first state.

FIG. 10D is a view showing a test result evaluated for the effects of the bump stopper according to Embodiment 6 of the invention, and schematically showing the bump stopper in a third state where the bump stopper has been most compressed and elastically deformed from the second state.

FIG. 10E is a view showing a test result evaluated for the effects of the bump stopper according to Embodiment 6 of the invention, and schematically showing the compression-load characteristics of a bump stopper which is a conventional product (an existing product).

FIG. 11A is a cross-sectional view showing a state where a bump stopper according to a modification of Embodiment 6 of the invention is assembled to a shock absorber.

FIG. 11B is a cross-sectional view showing a state where a bump stopper according to another modification of Embodiment 6 of the invention is assembled to a shock absorber.

FIG. 12A is a perspective view showing a portion of the construction at one end of the bump stopper subjected to air bleeding in an enlarged manner.

FIG. 12B is a perspective view showing a portion of the construction at the other end of the bump stopper subjected to air bleeding in an enlarged manner.

FIG. 13 is a cross-sectional view showing a state where a conventional bump stopper is used for a shock absorber.

FIG. 14 is a cross-sectional view showing the construction of another conventional bump stopper.

FIG. 15 is a cross-sectional view showing the construction of other conventional bump stoppers.

### EXPLANATION OF REFERENCE

1: BUMP STOPPER
4: BODY PORTION (CYLINDER BODY, MATING MEMBER)
6: PISTON ROD
11: BELLOWS PART
12: OUTWARDLY BULGED PART (FIRST PARTS)
13: INWARDLY RECESSED PART (SECOND PARTS)
100, 101, 1001: BUMP STOPPER
101a: UPPER END
101b: END LOCATED AT CYLINDRICAL BODY PORTION OF SHOCK ABSORBER
108: CUP
110: MOUNTING FITTING
111: BELLOWS PART
112: OUTWARDLY BULGED PART (FIRST PART)
113: INWARDLY RECESSED PART (SECOND PART)
112a: INCLINED PORTION
115, 115a, 115b, 115c: AXIAL DEVIATION REGULATING PORTION
208: BUMP STOPPER
214: SUPPORTING MEMBER (MATING MEMBER)
216: BELLOWS PART
H: LENGTH OF BELLOWS PART
R: EXTERNAL DIAMETER OF PISTON ROD
RE: EXTERNAL DIAMETER OF MOST BULGED PORTION
RI: INTERNAL DIAMETER OF INWARDLY RECESSED PART
RM: INTERNAL DIAMETER OF PART FORMED SO AS TO COME CLOSER TO PISTON ROD THAN INTERNAL DIAMETER OF OTHER SECOND PARTS
S: STROKE DIRECTION
P1: FIRST END OF BUMP STOPPER
P2: SECOND END OF BUMP STOPPER

### BEST MODE FOR CARRYING OUT THE INVENTION

Hereinafter, a bump stopper of the invention will be described with reference to the accompanying drawings.

### Embodiment 1

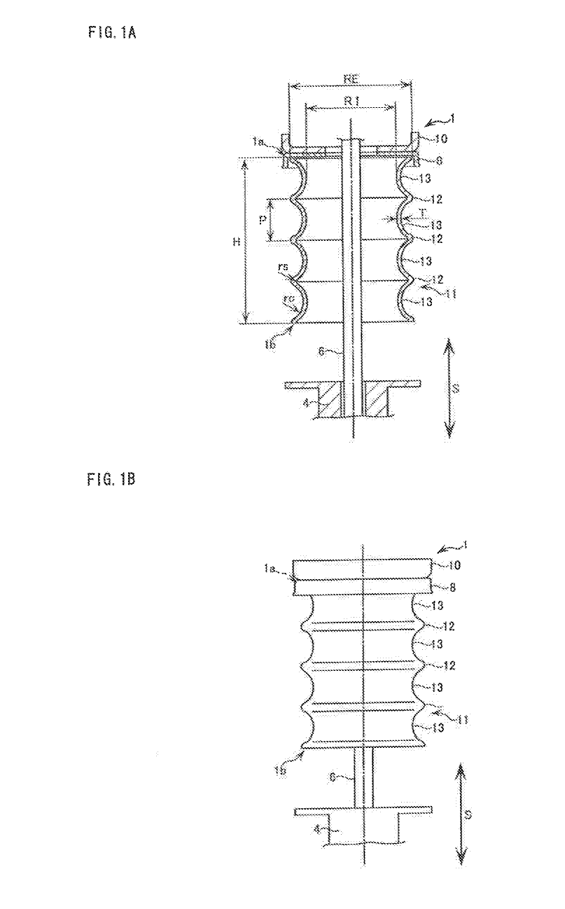

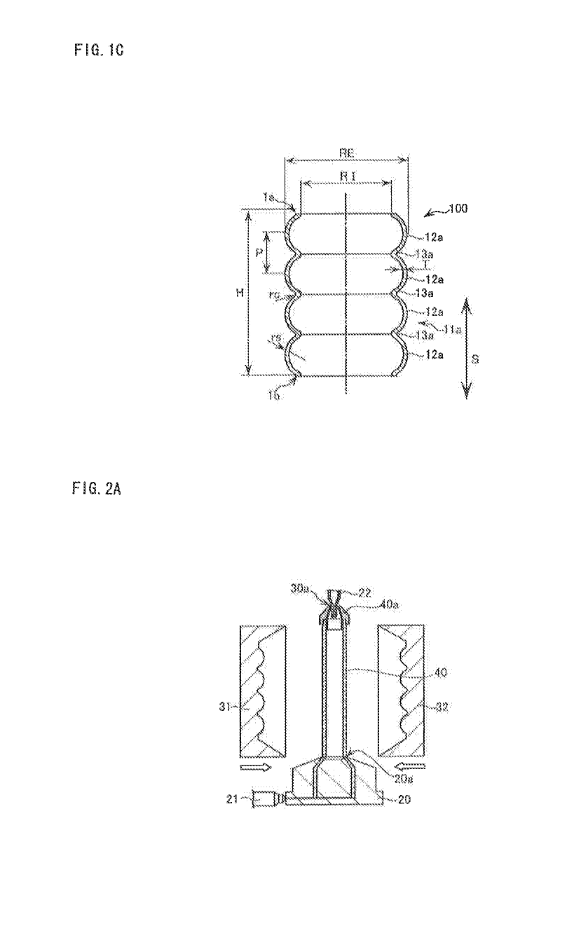

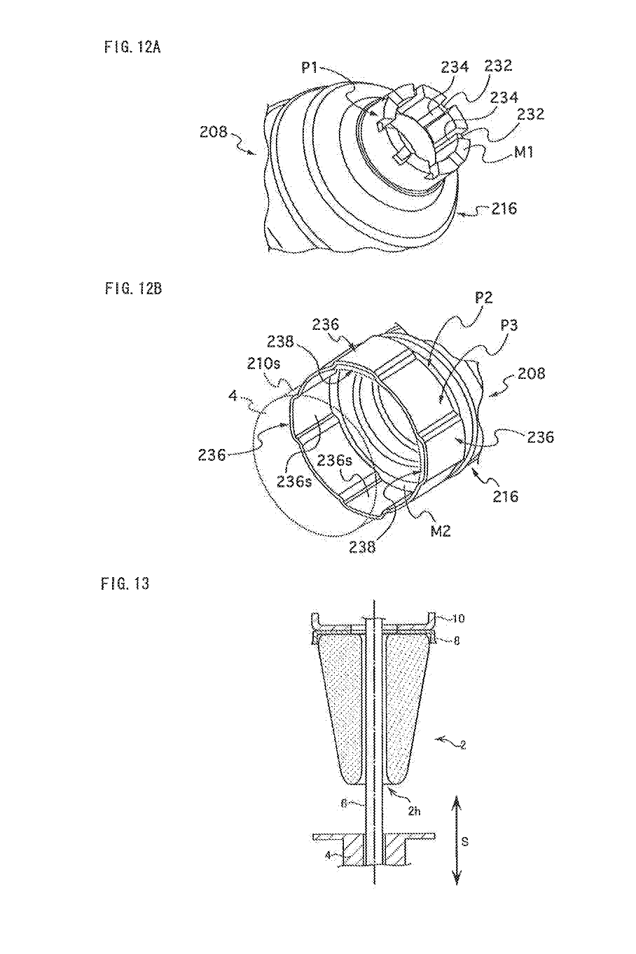

Since a bump stopper 1 according to Embodiment 1 of the invention, as shown in FIGS. 1A and 1B, is used so as to be provided coaxially with a piston rod 6 of a shock absorber instead of the conventional bump stopper 2 (refer to FIG. 13), the constituent elements of the shock absorber are designated using the same reference numerals as the constituent elements shown in FIG. 13, and thereby a description thereof is omitted. In addition, the bump stopper 1 may not necessarily be provided coaxially with the piston rod 6 of the shock absorber, and its attachment mode is arbitrary.

The bump stopper 1 includes a hollow cylindrical bellows part 11 which extends along a stroke direction S of the shock absorber and which functions as a shock-absorbing portion.

The bellows part 11 is constructed such that parts 12 (hereinafter referred to as “first parts 12”) which are molded by thinning thermoplastic resin and are bulged in a direction (radiation direction) opposite to the central direction, and parts 13 (hereinafter referred to as “second parts 13”) which are recessed in the central direction are alternately and repeatedly provided along the stroke direction S.

The second parts 13 each have an outer peripheral surface and an inner peripheral surface molded as a whole in the shape of a circular arc along the stroke direction, and the first part 12 provided between the adjacent second parts 13 and 13 also has an outer peripheral surface and an inner peripheral surface molded in the shape of a circular arc along the stroke direction.

Here, as an example, the radius of curvature rs of the outer peripheral surfaces of the first parts 12 in the stroke direction is set so as to become smaller than the radius of curvature rc of the outer peripheral surface of the second parts 13 in the stroke direction, and thereby, the bellows part are shaped such that the second parts 13 which are recessed in the shape of a circular arc with a large radius of curvature and the first parts 12 which are bulged in the shape of a circular arc with a small radius of curvature are alternate, integral, and continuous along the stroke direction S.

In addition, an example in which five first parts 12 and four second parts 13 are set from an upper end 1a of the bellows part 11 to a lower end 1b thereof is shown in the drawing. However, the invention is not limited thereto, and these parts can be changed so as to increase or decrease according to the intended use or application.

Additionally, since the specific numerical values of the radius of curvature rs of the first parts 12 and the radius of curvature rc of the second parts 13 depends on the shape, size, or the like of a shock absorber on which the a bump stopper 1 is mounted, and the arbitrary radii of curvature rs and rc may be set within a range where the radius of curvature rs of the first parts 12 becomes smaller than the radius of curvature rc of the second parts 13, the numerical values are not particularly limited here.

According to such a bellows part 11, the whole bellows part is formed as an elastic body which is expandable and contractible along the stroke direction S by the combination of the first parts 12 and the second parts 13. In this case, in an unloaded state where the load in the stroke direction S is not acting on the bellows part 11, the interval (pitch) P between the first parts 12 is elastically maintained at regular intervals along the stroke direction S.

In addition, “expandable and contractible” means that the bellows part 11 deforms and contracts elastically in the stroke direction according to a load from a natural length in the unloaded state, and the bellows part 11 expands to the natural length by an elastic restoring force after the load is released.

Additionally, the bellows part 11 has a constant small thickness T from the upper end 1a thereof to the lower end 1b thereof, and is formed such that the external diameter RE between the first parts 12 and the internal diameter RI between the second parts 13 become constant with respect to each other. In other words, the bellows part 11 is formed in a so-called cylindrical shape which is formed such that the external diameter dimensions RE of the most bulged portions are the same from the upper end 1a to the lower end 1b, and the internal diameter dimensions RI of the most recessed portions are the same from the upper end 1a to the lower end 1b.

According to such a bellows part 11, when the length H is reduced due to a shock in the stroke direction S, the first part 12 and the second part 13 which are adjacent to each other are elastically deformed so as to be folded on each other, thereby absorbing the shock. In this case, the small thickness T of the bellows part 11 may be a thickness dimension of such a degree that the first parts 12 and the second parts 13 are elastically deformable so as to be folded on each other. In addition, since arbitrary thickness dimensions are set according to the usage environment or intended use of a shock absorber on which the bump stopper 1 is mounted, a specific thickness dimension is not particularly limited here.

In addition, although the case where the bellows part 11 is formed with the constant small thickness T from the upper end 1a thereof to the lower end 1b thereof has been described in the present embodiment, the thickness T may not be constant as long as the bellows part is thinly formed. For example, the bellows part may be partially thickly formed, or may be thinly formed as long as the bellows part can exhibit the function as a bump stopper.

In addition, since the length H of the bellows part 11 is arbitrarily set according to the size or stroke amount of a shock absorber for which the bump stopper 1 is used, the length of the bellows part is not particularly limited here. Additionally, since the shapes of the upper end 1a and lower end 1b of the bellows part 11 are arbitrarily set according to the shape, size, or the like of a mounting portion of a shock absorber on which the bump stopper 1 is mounted, the shapes of the upper and lower ends are not particularly limited here.

Here, a method for manufacturing the bump stopper 1 of the present embodiment will be described.

The method for manufacturing the bump stopper 1 of the present embodiment is performed using a press-blow molding method, for example. A case where the bump stopper 1 is molded by the press-blow molding method will be described as an example.

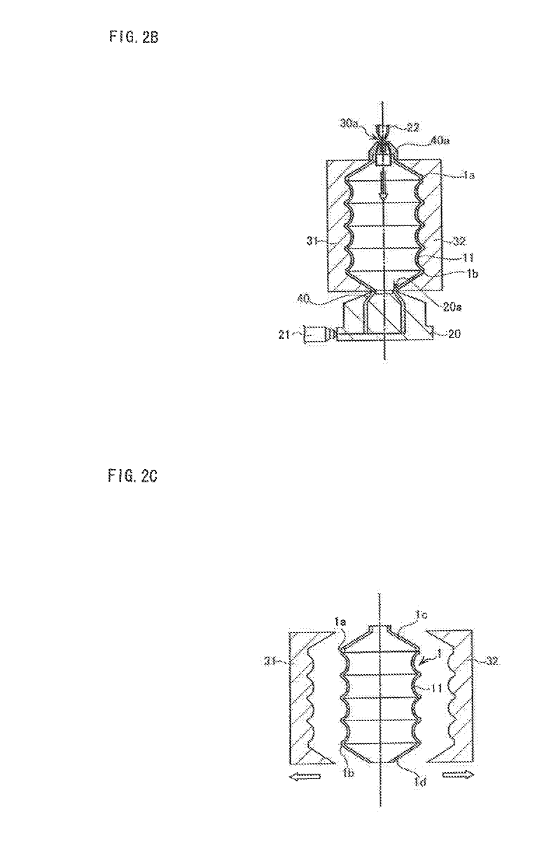

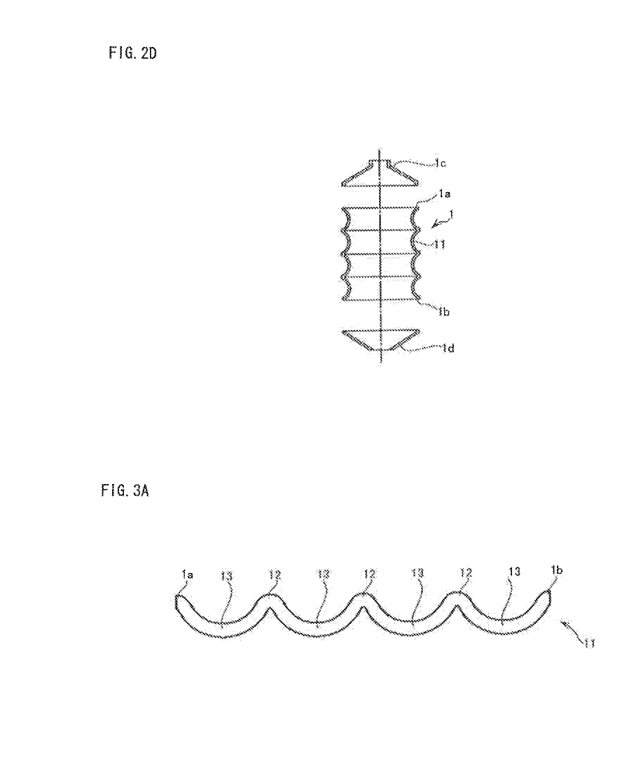

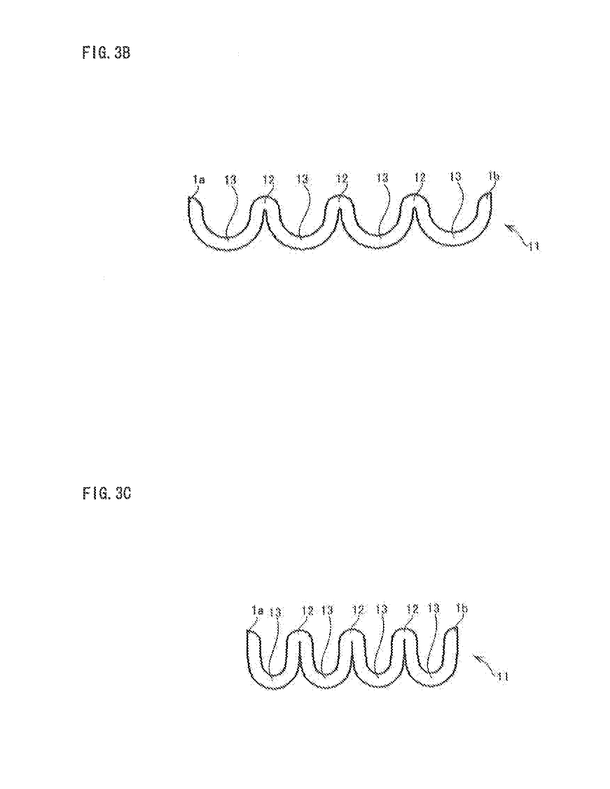

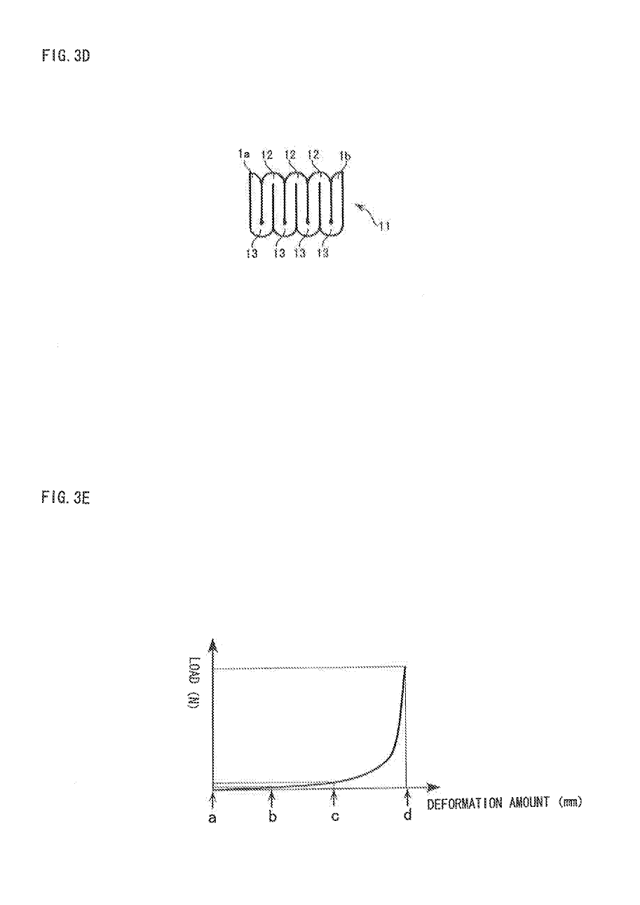

First, as shown in FIG. 2A, a melted thermoplastic resin material which has been extruded from an extruder 21 to a die 20 passes through an extrusion port 20a which is open annularly toward an upper portion of the die 20, and a portion thereof is supplied to and held by a pull-up member 40a. Thereafter, the resin material is pulled up such that the parison 40 has a desired thickness, while adjusting the pull-up speed of the pull-up member 40a and the extrusion amount of thermoplastic resin material. At this time, the parison 40 becomes a continuous tubular parison 40, and is pulled up to between a mold tool 31 and a mold tool 32 which are split (the process of forming a parison). In addition, the inner surfaces of the mold tool 31 and the mold tool 32 are formed with an undulating shape along the external contour of the bellows part 11.

Next, as shown in FIG. 2B, the mold tool 31 and the mold tool 32 are clamped together (refer to the inward pointing arrow in the drawing) (the process of setting mold tools).

Subsequently, as shown in this drawing, the gas (for example, air) compressed from a blow nozzle 22 is injected into the parison 40 of which one end is blocked by the die 20 all at once from a blowing-in port 30a of the pull-up member 40a (refer to a downward arrow in the drawing). Thereby, the parison 40 expands in the radial direction and comes into close contact with the inner surfaces of the mold tools 31 and 32. At this time, since the inner surfaces of the mold tools 31 and 32 are formed with an undulating shape along the external contour of the bellows part 11, the parison 40 comes into close contact with the mold tools in a thin-walled shape along the undulating shape.

After this, thermoplastic resin material is cooled and cured in the shape of the bellows part 11 by the cooled mold tools 31 and 32 (the process of molding a bellows part).

Then, as shown in FIG. 2C, the mold tools 31 and 32 are split (refer to an outward arrow in the drawing), and a cured molded product is removed. After this, as shown in FIG. 2D, the bump stopper 1 (bellows part 11) serving as an end product can be finished by cutting surplus portions 1c and 1d from the upper end 1a and lower end 1b of the molded product to become the bellows part 11.

In addition, although a method of clamping the mold tool 31 and the mold tool 32 (setting mold tools) together after the parison 40 is formed is illustrated in the present embodiment, the bump stopper 1 may be manufactured by clamping the mold tool 31 and the mold tool 32 together in advance (setting mold tools) and setting the formed parison 40 within the clamped mold tool 31 and mold tool 32.

As a thermoplastic resin for manufacturing the bump stopper 1 (bellows part 11), it is possible to apply a polyester-based thermoplastic elastomer. In addition, as thermoplastic resins other than this, for example, simple substances of an olefin-based elastomer, a urethane-based thermoplastic elastomer, and a polyamide-based elastomer or alloys of the simple substances with other thermoplastic resins may be applied.

In addition, although the case where the bump stopper 1 is manufactured by the press-blow molding method has been described in the present embodiment, the invention is not limited thereto, and the bump stopper may be manufactured by an extrusion-blow molding method or an injection-blow molding method. Other manufacturing methods (for example, an injection molding method) may be applied as long as the methods can manufacture the same bump stopper 1, and the manufacturing method is arbitrary.

As described above, the bump stopper 1 according to the present embodiment is molded in its entirety by thinning thermoplastic resin. Thus, compared to the conventional bump stopper 2 which is molded by thickening urethane foam resin, not only can the overall weight be reduced but also less resin material is required during manufacturing. Therefore, manufacturing costs can be kept down.

Additionally, since the bump stopper 1 according to the above present embodiment can be molded simply by blow-molding a parison made of thermoplastic resin without the necessity of performing a polymerization (chemical) reaction of two liquids unlike the conventional technique, the molding cycle can be extremely shortened and the manufacturing efficiency of the bump stopper 1 can be improved.

Additionally, since the bump stopper 1 according to the present embodiment is not a foam unlike a conventional product and has a so-called solid bellows shape in which air bubbles caused by foaming are not present, the dimensional precision of the bump stopper 1 serving as a finished product can be constantly maintained.

Additionally, the above thermoplastic resin has material characteristics capable of maintaining the durability thereof constantly under a wide range of temperature environments from high temperature to low temperature. For this reason, even if a vehicle to which the bump stopper 1 made of thermoplastic resin is applied is used in a cold region, the shock-absorbing characteristics of the bump stopper 1 can be maintained constantly for a prolonged period of time, and damage of the bump stopper 1 can be prevented even if the vehicle is used at an extremely low temperature.

Additionally, the above thermoplastic resin has material characteristics which have an excellent water resistance without being hydrolyzed. For this reason, in a case where a vehicle using the bump stopper 1 made of thermoplastic resin is used, for example, in a humid area with a lot of rain, or even in a case where the chassis of the vehicle is steam-washed, the durability performance of the bump stopper 1 can be constantly maintained for a prolonged period of time.

Moreover, the above thermoplastic resin can be reused (recycled) as a molding material as is, for example, the surplus portions 1c and 1d cut during manufacturing or the used bump stopper 1 can be collected, and this can be recycled as a molding material for manufacturing a new bump stopper 1. Thereby, the material yield rate can be improved, and an ecological bump stopper 1 for which the global environment is also taken into consideration can be provided.

Here, a test result evaluated for the effects of the bump stopper 1 as described above will be described.

In the evaluation test, as for an initial state (unloaded state) (FIG. 3A) where the bump stopper 1 of the invention is not compressed, for example, a first state (FIG. 3B) where the bump stopper has been gradually compressed, for example, a second state (FIG. 3C) where the bump stopper has been further compressed, and for example, a third state (FIG. 3D) where the bump stopper has been most compressed, the compressed state (deformed state: deformation amount) of the bump stopper 1 and the load at the time of compression in the individual states were evaluated by contrasting with the deformation amount-load characteristics (FIG. 3E) of a conventional product (existing product).

According to this, it can be seen that the compression-load characteristics of the bump stopper 1 of the invention are almost the same as those of the conventional product, at point a (initial state), point b (first state), point c (second state), and point d (third state) in FIG. 3E. Thereby, it was confirmed that the bump stopper 1 of the invention has the same performance (for example, shock-absorbing characteristics) as a conventional product.

In addition, the invention is not limited to the above-described present embodiment, and the same effects as those of the bump stopper 1 of the above-described present embodiment are exhibited even in the following individual modifications.

As a first modification, for example, as shown in FIG. 1C, in a bump stopper 100 (bellows part 11a), the radius of curvature rs, in the stroke direction, of the outer peripheral surfaces of the first parts 12a which are bulged in a direction opposite to the central direction may be set so as to be greater than the radius of curvature rc, in the stroke direction, of the outer peripheral surfaces of the second parts 13a which are recessed in the central direction.

This bump stopper is formed so as to have such a shape that the inner peripheral surface and outer peripheral surface of the bump stopper 1 (bellows part 11) according to the above-described present embodiment are reversed.

In addition, since other constituent elements are the same as those of the bump stopper 1 according to the above-described present embodiment, the description thereof is omitted.

Additionally, the bellows part 11 of the above-described present embodiment and the bellows part 11a according to the first modification are formed such that the external diameter dimensions RE of the most bulged portions are the same from the upper end 1a to the lower end 1b, and the internal diameter dimensions RI of the most recessed portion are the same from the upper end 1a to the lower end 1b. However, the external diameter dimensions RE and the internal diameter dimensions RI may not be the same from the upper end 1a of the bellows part 11 (bellows part 11a) to the lower end 1b thereof.

As a second modification, for example, the bellows part 11 (bellows part 11a) may be formed such that the external diameter dimension RE and the internal diameter dimension RI become gradually smaller toward the lower end 1b, and thus the overall shapes thereof may be formed in a taper shape. Otherwise, the bellows part 11 (bellows part 11a) may be formed such that the external diameter dimension RE and the internal diameter dimension RI become gradually greater toward the lower end 1b, and thus the overall shapes thereof may be formed in a fan shape (not shown). Additionally, for example, the overall shape of the bellows part 11 (bellows part 11a) may be narrowed in a so-called hourglass shape such that the middle thereof becomes smaller than the upper end 1a and the lower end 1b, or may be swelled in a so-called drum shape such that the middle thereof becomes greater than the upper end 1a and the lower end 1b.

Additionally, in the above-described present embodiment and first and second modifications, the case where the first parts 12 and second parts 13 are integrally continuous in a smooth curve in the stroke direction is assumed. However, the invention is not limited thereto. The first parts 12 and the second parts 13 may be molded such that only the top portions thereof are molded in the shape of a circular arc in the stroke direction, and the portions between adjacent top portions are integrally continuous in the shape of a straight line.

By molding at least the top portions in the shape of a circular arc in this way, the above stress concentration to each top portion can be relaxed when the bellows part 11 (bellows part 11a) has contracted.

Additionally, the intervals (pitches) P between the first parts 12 may not be regular intervals along the stroke direction S, and the radius of curvature rs of the first parts 12 and the radius of curvature rc of the second parts 13 do not need to be constant, respectively, and may be different, respectively.

Additionally, the case where the outer peripheral surfaces and inner peripheral surfaces of the first parts 12 (12a) and the second parts 13 (13a) are constructed in the shape of a circular arc with a constant radius of curvature from the top portion to the bottom portion is illustrated in the present embodiment and the first modification. However, the outer peripheral surfaces and inner peripheral surfaces of the first parts 12 (12a) and second parts 13 (13a) do not need to be constructed in the shape of a circular arc with a constant radius of curvature from the top portion thereof the bottom portion thereof, for example, the radius of curvature of the top portion may be different from the radius of curvature of the bottom portion. The “circular arc shape” of the invention does not mean only a circular arc with a constant radius of curvature along the stroke direction S, and is used to mean that the first and second parts are formed in the shape of a circular arc with radii of curvature which are partially different along the stroke direction S, or are formed in the shape of a circular arc when seen as a whole even if straight line portions are partially included.

### Embodiment 2

Next, the bump stopper 101 related to Embodiment 2 will be described with reference to the accompanying drawings.

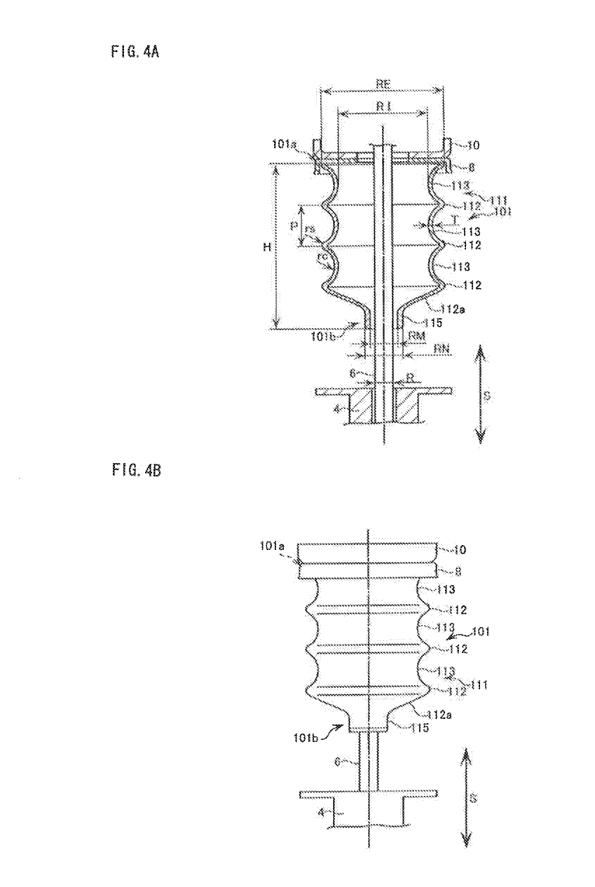

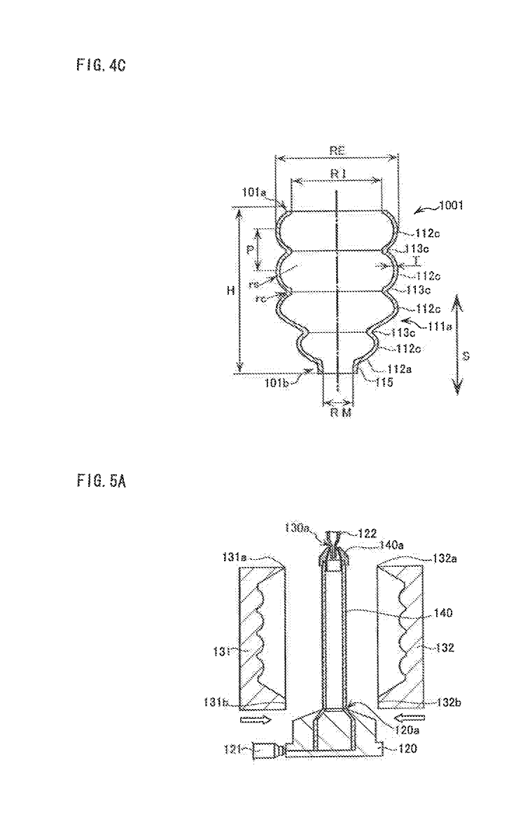

As shown in FIGS. 4A and 4B, since a bump stopper 101 according to the present embodiment is used so as to be provided coaxially with a piston rod 6 of a shock absorber instead of the conventional bump stopper 2 (refer to FIG. 13); the constituent elements of the shock absorber are designated using the same reference numerals as the constituent elements shown in FIG. 13, and thereby the description thereof is omitted.

The bump stopper 101 of the present embodiment, as shown in FIGS. 4A and 4B, includes a hollow cylindrical bellows part 111 which extends along the stroke direction S of the shock absorber and which is elastically expandable and contractible along the stroke direction S.

More specifically, the bellows part 111 is constructed such that first parts 112 which are molded by thinning thermoplastic resin and are bulged in a direction (radiation direction) opposite to a central direction, and second parts 113 which are recessed in the central direction are alternately and repeatedly provided along the stroke direction S.

The second parts 113 each have an outer peripheral surface and an inner peripheral surface molded as a whole in the shape of a circular arc along the stroke direction, and the first part 112 provided between the adjacent second parts 113 and 113 also has an outer peripheral surface and an inner peripheral surface molded in the shape of a circular arc along the stroke direction S.

Moreover, an axial deviation regulating portion 115 which is continuous from a first part 112 of the bellows part 111 and of which the diameter is reduced in the central direction is formed at the end of the bump stopper 101 located on the side of the shock absorber such that the internal diameter RM thereof comes closer to the piston rod 6 than the internal diameter RI of the second parts 113.

In the present embodiment, one axial deviation regulating portion 115 is disposed at one end in the stroke direction S, i.e., at one end 101b of the bump stopper 101 located at a cylindrical body portion 4 (cylinder body) of the shock absorber, and the axial deviation regulating portion 115 is formed in a cylindrical shape which has a constant internal diameter RM and has a constant external diameter RN with a smaller diameter than the internal diameter RI of the second parts.

In this case, the positional relationship between the axial deviation regulating portion 115 (internal diameter RM) and the piston rod 6 (external diameter R) is preferably set so as to be brought into a state where a slight gap exist therebetween. In addition, when the bellows part 111 has expanded and contracted elastically in the stroke direction S, the size of the gap may be set to such an extent that the axial deviation regulating portion 115 does not move in a direction deviated from the stroke direction S.

Here, as an example of such a bellows part 111, the radius of curvature rs of the outer peripheral surfaces of the first parts 112 in the stroke direction S is set so as to become smaller than the radius of curvature rc of the outer peripheral surfaces of the second parts 113 in the stroke direction S, and thereby, the bellows part is shaped such that the second parts 113 which are recessed in the shape of a circular arc with a large radius of curvature and the first parts 112 which are bulged in the shape of a circular arc with a small radius of curvature are alternate, integral, and continuous along the stroke direction S. Additionally, the axial deviation regulating portion 115 and the first part 112 adjacent to the axial deviation regulating portion 115 are integrally molded (connected) by a smoothly continuous inclined portion 112a.

In addition, since the specific numerical values of the radius of curvature rs of the first parts 112 and the radius of curvature rc of the second parts 113 depend on the shape, size, or the like of a shock absorber on which the bump stopper 1 is mounted, and the arbitrary radii of curvature rs and rc may be set within a range where the radius of curvature rs of the first parts 112 becomes smaller than the radius of curvature rc of the second parts 113, the numerical values are not particularly limited here.

Additionally, the bump stopper 101 is formed with a constant small thickness T from the upper end 101a to the end 101b located at the cylindrical body portion 4 side of the shock absorber, and is formed such that the external diameter dimensions RE of the most bulged portions of the first parts 112 are the same and the internal diameter dimensions RI of the most recessed portions of the second parts 113 are the same.

In addition, although the internal diameter RM is set to have a slightly larger diameter than the external diameter R of the piston rod 6 on the drawing, the internal diameter may be set so as to coincide substantially with the external diameter R of the piston rod 6.

According to such a bump stopper 101, the whole bellows part is formed as an elastic body which is expandable and contractible along the stroke direction S by the combination of the first parts 112 and the second parts 113. In this case, in an unloaded state where the load in the stroke direction S is not acting on the bump stopper 101, the interval (pitch) P between the first parts 12 is elastically maintained at regular intervals along the stroke direction S.

In addition, “expandable and contractible” means that the bellows part 111 deforms and contracts elastically in the stroke direction according to a load from the natural length of the bump stopper 101 in the unloaded state, and the bump stopper 101 is extended to the natural length by an elastic restoring force of the bellows part 111 after the load is released.

Here, if the shock when the stroke of the piston rod 6 reaches an allowable limit (bump touch) acts on the bump stopper 101 when a load acts on the suspension and the piston rod 6 of the shock absorber has extended and retracted with respect to the body portion 4, the bellows part 111 deforms elastically, thereby absorbing the shock such that the first part 112 and the second part 113 which are adjacent to each other are folded on each other when the length H (the length of the bump stopper 101 along the stroke direction S from the upper end 101a to the end 101b located at the cylindrical body portion 104 of the shock absorber) is reduced due to the shock in the stroke direction S.

In this case, since the axial deviation regulating portion 115 and the piston rod 6 are in a state (state where the axial deviation regulating portion and the piston rod approach each other) where the above slight gap exists therebetween, the axial deviation regulating portion 115 moves without deviating from the stroke direction S along the piston rod 6 while being guided by the piston rod 6, i.e., without deviating axially.

At this time, the bump stopper 101 deforms elastically so as to follow the movement of the axial deviation regulating portion 115 in the stroke direction S and so as to be folded on itself while maintaining a predetermined posture, without deviating axially from the stroke direction S in its entirety.

Thereby, the bump stopper 101 (bellows part 111) deforms elastically and contracts in a direction which coincides with in the stroke direction S, so that a shock can be stably and efficiently absorbed.

In addition, in this case, the small thickness T of the bellows part 111 may be a thickness dimension of such a degree that the first parts 112 and the second parts 113 are elastically deformable so as to be folded on each other.

Additionally, since arbitrary thickness dimensions are set according to the usage environment or intended use of a shock absorber on which the bump stopper 101 is mounted, a specific thickness dimension is not particularly limited here.

Although the case where the bellows part 111 is formed with the constant small thickness T from the upper end 101a thereof to the end 101b thereof located at the cylindrical body portion 4 side of the shock absorber has been described in the present embodiment, the thickness T may not be constant as long as the bellows part is thinly formed. For example, the bellows part may be partially thickly formed, or may be thinly formed as long as the bellows part can exhibit the function as a bump stopper 1.

In addition, since the length H of the bump stopper 101 is arbitrarily set according to the size or stroke amount of a shock absorber for which the bump stopper 101 is used, the length of the bump stopper is not particularly limited here. Additionally, since the shapes of the upper end 101a and the end 101b located at the cylindrical body portion 4 side of the shock absorber in the bump stopper 101 are arbitrarily set according to the shape, size, or the like of a mounting portion of a shock absorber on which a bump stopper 101 is mounted if the axial deviation regulating portion 115 is formed so as to come closer to the piston rod 6 than the internal diameter RI of the other second parts 113, the shapes of the above ends are not particularly limited here.

Although the case where the axial deviation regulating portion 115 is disposed at one end in the stroke direction S, i.e., at the end 101b located at the shock absorber has been described in the present embodiment, the arrangement of the axial deviation regulating portion 115 is not limited thereto. For example, the axial deviation regulating portion may be disposed at the other end (i.e., the upper end 101a) in the stroke direction S, or at any place between one end and the other end. In addition, as the axial deviation regulating portion 115 is arranged closer to the cylindrical body portion 4 side of the shock absorber (closer to the end 101b), the effect of regulating an axial deviation is higher. Thus, even in a case where the axial deviation regulating portion 115 is arranged at places other than the end 101b, it is preferable that the axial deviation regulating portion be arranged as close to the cylindrical body portion 4 side of the shock absorber (closer to the end 101b) as possible.

Additionally, as for the number of axial deviation regulating portions 115 to be arranged, two or more axial deviation regulating portions 115 may be disposed, or the number of the axial deviation regulating portions may be arbitrarily set according to the length H of the bellows part 111. Additionally, although the example in which a slight gap exists between the axial deviation regulating portion 115 and the piston rod 6 is illustrated in the drawings, the invention is not limited thereto, and the axial deviation regulating portion 115 may come into sliding contact with the piston rod 6.

As for the number of first parts 112 and second parts 113, the example in which three first part 112 and three second parts 113 are set from the upper end 101a of the bellows part 111 to the lower end 101b thereof is shown in the drawings. However, the invention is not limited thereto, and these parts can be changed so as to increase or decrease according to the intended use or applications.

Here, a method for manufacturing the bump stopper 101 of the present embodiment will be described.

The method for manufacturing the bump stopper 101 of the present embodiment is performed by a press-blow molding method, for example. A case where the bump stopper 101 is molded by the press-blow molding method will be described as an example.

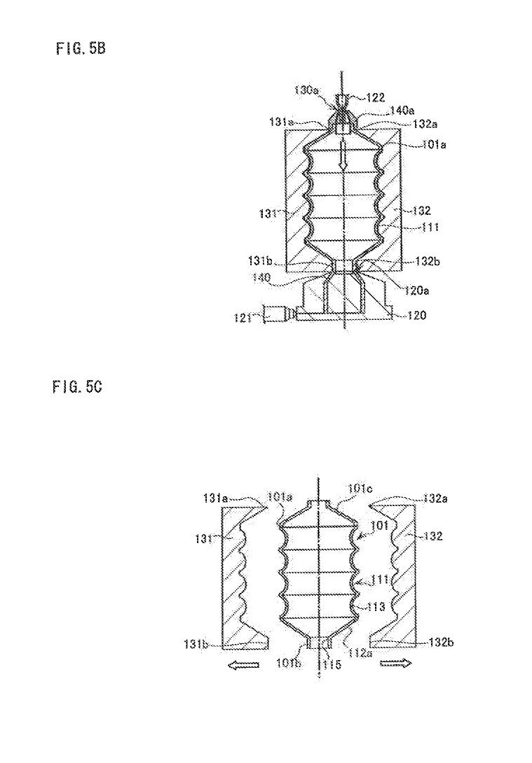

First, as shown in FIG. 5A, a melted thermoplastic resin material which has been extruded from an extruder 121 to a die 120 passes through an extrusion port 120a which is open annularly toward an upper portion of the die 120, and a portion thereof is supplied to and held by a pull-up member 140a. Thereafter, the resin material is pulled up such that the parison 140 has a desired thickness, while adjusting the pull-up speed of the pull-up member 140a and the extrusion amount of thermoplastic resin material. At this time, the parison 140 becomes a continuous tubular parison 140, and is pulled up to between a mold tool 131 and a mold tool 132 which are split (the process of forming a parison).

In addition, the inner surfaces of the mold tool 131 and the mold tool 132 are formed with an undulating shape along the external contour of the bellows part 111, inner surfaces 131a and 132a at upper ends of the mold tool 131 and the mold tool 132 are formed by protruding such that the inner surfaces 131a and 132a match the external diameter of the pull-up member 140a in a case where the mold tool 131 and the mold tool 132 are put together, and inner surfaces 131b and 132b at lower ends of the mold tool 131 and the mold tool 132 protrude further from the undulated shape, and are formed by being stretched downward such that the inner surfaces 131a and 132a match an extrusion port 120a in a case where the mold tool 131 and the mold tool 132 are put together.

Next, as shown in FIG. 5B, the mold tool 131 and the mold tool 132 are clamped together (refer to an inward arrow in the drawing) (the process of setting mold tools).

Subsequently, as shown in this drawing, the gas (for example, air) compressed from a blow nozzle 122 is injected into the parison 140 of which one end is blocked by the die 120 all at once from a blowing-in port 130a of the pull-up member 140a (refer to a downward arrow in the drawing). Thereby, the parison 140 expands in the radial direction and comes into close contact with the inner surfaces of the mold tools 131 and 132. At this time, since the inner surfaces of the mold tools 131 and 132 are formed with an undulating shape along the external contour of the bellows part 111, the parison 140 comes into close contact with the mold tools in a thin-walled shape along the undulating shape.

After this, thermoplastic resin material is cooled and cured in the shape of the bellows part 111 by the cooled mold tools 131 and 132 (the process of molding a bellows part).

Then, as shown in FIG. 5C, the mold tools 131 and 132 are separated (refer to the outward pointing arrow in the drawing), and a cured molded product is removed. After this, as shown in FIG. 5D, the bump stopper 101 (bellows part 111) serving as an end product can be finished by cutting a surplus portion 101c from the molded product to become the bellows part 111.

In this case, in the molded product, the side (upside in the drawing) where the surplus portion 101c of the bellows part 111 is cut becomes the upper end 101a, and the downside in the drawing becomes the end 101b located at the cylindrical body portion 4 of the shock absorber.

In addition, since the bump stopper 101 of the present embodiment is shaped such that the internal diameter RM of the axial deviation regulating portion 115 at the end 101b located at the cylindrical body portion 4 side of the shock absorber comes closer to the piston rod 6 than the internal diameter RI of the other second parts 113, the manufacturing method using the mold tools 131 and 132 suited to the shape of the bump stopper has been described. However, in a case where a stopper 101 in which the axial deviation regulating portion 115 is disposed at other positions is manufactured, the contour of the inner surfaces of the mold tools 131 and 132 may be formed in conformity with a shape in a case where the axial deviation regulating portion 115 is disposed at other positions. For example, in a case where the axial deviation regulating portion 115 is at the center between the upper end 101a and the end 101b located at the cylindrical body portion 4 side of the shock absorber, the undulating shape of the inner surfaces of the mold tools 131 and 132 may be formed by protruding so as to match the position of the axial deviation regulating portion 115.

In addition, although a method of clamping the mold tool 131 and the mold tool 132 (setting mold tools) together after the parison 140 is formed is illustrated in the present embodiment, the bump stopper 101 may be manufactured by clamping the mold tool 131 and the mold tool 132 together in advance (setting mold tools) and setting the formed parison 140 within the clamped mold tool 131 and mold tool 132.

As a thermoplastic resin for manufacturing the bump stopper 101 (bellows part 111), it is possible to apply a polyester-based thermoplastic elastomer. In addition, as thermoplastic resins other than this, for example, simple substances of an olefin-based elastomer, a urethane-based thermoplastic elastomer, and a polyamide-based elastomer or alloys of the simple substances with other thermoplastic resins may be applied.

In addition, although the case where the bump stopper 1 is manufactured by the press-blow molding method has been described in the present embodiment, the invention is not limited thereto, and the bump stopper may be manufactured by an extrusion-blow molding method or an injection-blow molding method. Other manufacturing methods (for example, an injection molding method) may be applied as long as the methods can manufacture the same bump stopper 101, and the manufacturing method is arbitrary.

According to the bump stopper 101 according to the present embodiment, at least one axial deviation regulating portion 115 is recessed in the central direction and formed so as to come closer to the piston rod 6 than the internal diameter RI of other second parts 113. Thereby, during expansion and contraction of the bump stopper 101 (bellows part 111), the axial deviation regulating portion 115 moves without deviating from the stroke direction S along the piston rod 6 while being guided by the piston rod 6, i.e., without deviating axially. Thus, the entire bump stopper 101 (bellows part 111) can be elastically deformed so as to follow the movement of the axial deviation regulating portion and so as to be folded on itself while maintaining a predetermined posture, without deviating axially from the stroke direction S. As a result, it is possible to realize the bump stopper 101 capable of stably and efficiently absorbing the shock at the time of the above bump touch while maintaining the shock-absorbing characteristics of the bellows part 111 itself.

Additionally, the bump stopper 101 according to the present embodiment is molded in its entirety by thinning thermoplastic resin. Thus, compared to the conventional bump stopper 2 which is molded by thickening urethane foam resin, not only can the overall weight be reduced but also less resin material is required during manufacturing. Therefore, manufacturing costs can be kept down.

Additionally, since the bump stopper 101 according to the above present embodiment can be molded only by blow-molding a parison made of thermoplastic resin, the molding cycle can be extremely shortened and the manufacturing efficiency of the bump stopper 101 can be improved.

Additionally, since the bump stopper 101 according to the present embodiment is not a foam unlike a conventional product and has a so-called solid bellows shape in which air bubbles caused by foaming are not present, the dimensional precision of the bump stopper 101 serving as a finished product can be maintained constantly.

Additionally, the above thermoplastic resin has material characteristics capable of maintaining the durability thereof constantly under a wide range of temperature environments from a high temperature to a low temperature. For this reason, even if a vehicle to which the bump stopper 101 made of thermoplastic resin is applied is used in a cold region, the shock-absorbing characteristics of the bump stopper 101 can be maintained constantly for a prolonged period of time, and damage of the bump stopper 101 can be prevented even if the vehicle is used under an extremely low temperature.

Additionally, the above thermoplastic resin has material characteristics which have an excellent water resistance without being hydrolyzed. For this reason, in a case where a vehicle using the bump stopper 101 made of thermoplastic resin is used, for example, in a humid area with a lot of rain, or even in a case where the chassis of the vehicle is steam-washed, the durability performance of the bump stopper 101 can be maintained constantly for a prolonged period of time.

Moreover, the above thermoplastic resin can be reused (recycled) as a molding material as is, for example, the surplus portion 1c cut during manufacturing or the used bump stopper 101 can be collected, and this can be recycled as a molding material for manufacturing a new bump stopper 101. Thereby, the material yield rate can be improved, and an ecological bump stopper 101 for which the global environment is also taken into consideration can be provided.

In addition, the invention is not limited to the above-described present embodiment, and the same effects as those of the bump stopper 101 of the above-described present embodiment are exhibited even in the following individual modifications.

As a first modification, the first parts 112 and second parts 113 which are shown in FIG. 4A may be reversed. That is, as shown in FIG. 4C, in a bump stopper 1001 (bellows part 111a), the radius of curvature rs, in the stroke direction S, of the outer peripheral surfaces of the first parts 112c which are bulged in a direction opposite to the central direction may be set so as to be greater than the radius of curvature rc, in the stroke direction S, of the outer peripheral surfaces of the second parts 113c which are recessed in the central direction.

This bump stopper is formed so as to have such a shape that the inner peripheral surface and outer peripheral surface of the bump stopper 101 (bellows part 111) according to the above-described present embodiment are reversed. However, even in this case, the internal diameter RM of the axial deviation regulating portion 115 (located on the lowermost side in the drawing) is formed so as to come closer to the piston rod 6 than the internal diameter RI of the second parts 113c.

In addition, since other constituent elements are the same as those of the bump stopper 101 according to the above-described present embodiment, the description thereof is omitted.

Additionally, the bump stopper 101 according to the above-described present embodiment and the bump stopper 1001 according to the first modification are formed such that the external diameter dimensions RE of the most bulged portions are the same and the internal diameter dimensions RI of the most recessed portions of the second parts 113 excluding the above axial deviation regulating portion 115 are the same. However, the external diameter dimensions RE and the internal diameter dimensions RI may not be the same from the upper end 101a of the bump stopper 101 or 1001 to the lower end 101b thereof as long as the internal diameter RM of at least one axial deviation regulating portion 115 among the second part 113 is formed so as to come closer to the piston rod 6 than the internal diameter RI of other second parts 113.

As a second modification, for example, the bump stoppers 101 and 1001 may be formed such that the external diameter dimension RE and the internal diameter dimension RI become gradually smaller toward the lower end 101b, and thus the overall shapes thereof may be formed in a taper shape. Otherwise, the bump stoppers 101 and 1001 may be formed such that the external diameter dimension RE and the internal diameter dimension RI become gradually greater toward the lower end 101b, and thus the overall shapes thereof may be formed in a fan shape (not shown). Additionally, for example, the overall shapes of the bump stopper 101 and 1001 may be narrowed in a so-called hourglass shape such that the middle thereof becomes smaller than the upper end 101a and the lower end 101b, or may be swelled in a so-called drum shape such that the middle thereof becomes greater than the upper end 101a and the lower end 101b.

Additionally, in the above-described present embodiment, the case where the first parts 112 and second parts 113 are integrally continuous in a smooth curve in the stroke direction S is assumed. However, the invention is not limited thereto. The first parts 112 and the second parts 113 may be molded such that only the top portions thereof are molded in the shape of a circular arc in the stroke direction S, and the portions between adjacent top portions are integrally continuous in the shape of a straight line.

By molding at least the top portions in the shape of a circular arc in this way, the above stress concentration to each top portion can be relaxed when the bump stoppers 101 and 1001 is contracted.

Additionally, the intervals (pitches) P between the first parts 112 may not be regular intervals along the stroke direction S, and the radius of curvature rs of the first parts 112 and the radius of curvature rc of the second parts 113 do not need to be constant, respectively, and may be different, respectively.

Additionally, the case where the outer peripheral surfaces and inner peripheral surfaces of the first parts 112 (112c) and the second parts 113 (113c) are constructed in the shape of a circular arc with a constant radius of curvature from the top portion to the bottom portion is illustrated in the present embodiment and the first modification. However, the outer peripheral surfaces and inner peripheral surfaces of the first parts 112 (112c) and second parts 113 (113c) do not need to be constructed in the shape of a circular arc with a constant radius of curvature from the top portion thereof the bottom portion thereof, for example, the radius of curvature of the top portion may be different from the radius of curvature of the bottom portion. The “circular arc shape” of the invention does not mean only a circular arc with a constant radius of curvature along the stroke direction S, and is used to mean that the first and second parts are formed in the shape of a circular arc with radii of curvature which are partially different along the stroke direction S, or are formed in the shape of a circular arc when seen as a whole even if straight line portions are partially included.

### Embodiment 3

In Embodiment 2 described above, the case where the axial deviation regulating portion 115 is formed in a cylindrical shape which has a constant internal diameter RM and has a constant external diameter RN with a smaller diameter than the internal diameter RI of the second parts has been described. However, the external diameter RN of the axial deviation regulating portion 115 does not need to be formed with a smaller diameter than the internal diameter RI of the second parts 113.

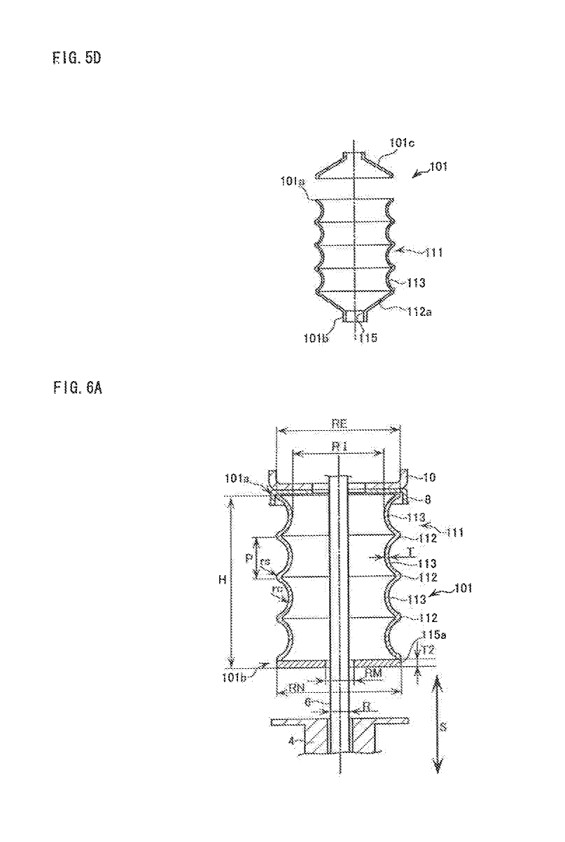

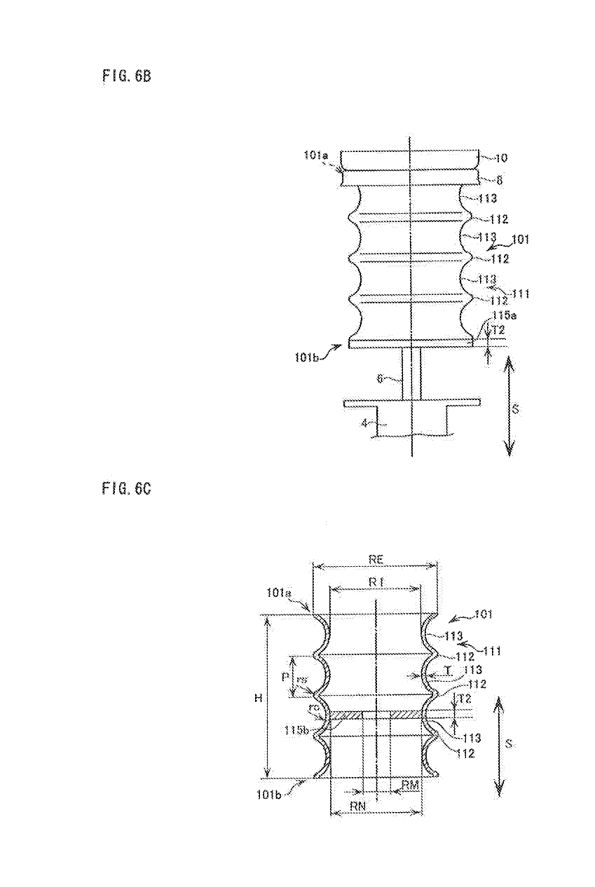

For example, one axial deviation regulating portion 115a of the bump stopper 1 of Embodiment 3, as shown in FIGS. 6A and 6B, is disposed at one end in the stroke direction S, i.e., at one end 101b of the bellows part 111 located at the cylindrical body portion 4 side of the shock absorber, and is bonded such that the external diameter RN set to have the same diameter as the external diameter dimensions RE of the most bulged portions of the first parts 112 becomes continuous integrally with the first parts 112 adjacent to the axial deviation regulating portion 115a.

Even in the present embodiment, the internal diameter RM of the axial deviation regulating portion 115a is formed so as to come closer to the piston rod 6 than the internal diameter RI of the second parts 113, and thereby, a disk with a constant predetermined thickness T2 is constructed between the internal diameter RI and external diameter RN of the axial deviation regulating portion 115a.

The positional relationship between the axial deviation regulating portion 115a (internal diameter RM) and the piston rod 6 (external diameter R), similarly to the above-described first embodiment, is preferably set so as to be brought into a state where a slight gap exists therebetween. In addition, when the bump stopper 101 (bellows part 111) has expanded and contracted elastically in the stroke direction S, the size of the gap may be set to such an extent that the axial deviation regulating portion 115a does not move in a direction deviated from the stroke direction S.

In this case, the thickness T2 of the axial deviation regulating portion 115a may have a thickness dimension with a strength such that the shape of the disk does not deform when the axial deviation regulating portion is guided by the piston rod 6. Additionally, since arbitrary thickness dimensions are set according to the usage environment or intended use of a shock absorber on which the bump stopper 101 is mounted, a specific thickness dimension is not particularly limited here. Additionally, although the case where the thickness T is kept constant has been described in the present embodiment, the thickness T may not be constant as long as the thickness has a strength such that the shape of the disk does not deform.

In addition, since other constituent elements are the same as those of the bump stopper 101 according to the above-described Embodiment 2, the description thereof is omitted.

Even in a case where the axial deviation regulating portion 115a is formed like the present embodiment, the same effects as the above-described Embodiment 2 can be obtained. That is, since the internal diameter RM thereof is reduced in the central direction so as to come closer to the piston rod 6 than the internal diameter RI of the second parts 113, the axial deviation regulating portion 115a moves without deviating from the stroke direction S along the piston rod 6 while being guided by the piston rod 6, i.e., without deviating axially.

Additionally, as the first modification of the axial deviation regulating portion 115a of the present embodiment, the axial deviation regulating portion may be provided at places other than the end 101b located at the cylindrical body portion 4 of the shock absorber.

For example, one axial deviation regulating portion 115b of the bump stopper 101 of the present modification, as shown in FIG. 6C, is disposed at the second part 113 of the bellows part 111 at a second position in the direction of the upper end 101a from one end 101b located at the cylindrical body portion 4 side of the shock absorber, and is bonded such that the external diameter RN set to have the same diameter as the internal diameter RI of the second parts 113 becomes continuous integrally with the internal diameter RI portion of the second part 113 at a second position in the direction of the upper end 101a from one end 101b.

Even in this case, the internal diameter RM of the axial deviation regulating portion 115a is formed so as to come closer to the piston rod 6 than the internal diameter RI of the second parts 113, and thereby, a disk with a constant predetermined thickness T2 is constructed between the internal diameter RI and external diameter RN of the axial deviation regulating portion 115a.

As such, even if the axial deviation regulating portion 115b is provided at the bellows part 111 other than the end 101b located at the cylindrical body portion 4 side of the shock absorber, the same effects as the above-described Embodiment 2 are exhibited if the diameter is reduced in the central direction such that the internal diameter RM comes closer to the rod 6 than the internal diameter RI of the second parts 113.

In addition, even in this case, as the axial deviation regulating portion 115 is arranged closer to the cylindrical body portion 4 of the shock absorber (closer to the end 101b), the effect of regulating an axial deviation is higher. Thus, it is preferable that the axial deviation regulating portion be arranged as close to the cylindrical body portion 4 side of the shock absorber (closer to the end 101b) as possible. Since other constituent elements are the same as those of the bump stopper 101 according to the above-described Embodiment 2, the description thereof is omitted.

### Embodiment 4

Additionally, a plurality of axial deviation regulating portions 115 of the above-described Embodiments 2 and 3 may be disposed. For example, both the axial deviation regulating portion 115a arranged at the end 101b located at the cylindrical body portion 4 side of the shock absorber and the axial deviation regulating portion 115b arranged at places other than the end 101b may be disposed. In this case, since parts which regulate an axial deviation along the stroke direction S of the bump stopper 101 increases, the effect of regulating the axial deviation becomes higher.

### Embodiment 5

Additionally, although the case where the axial deviation regulating portion 115 is provided at the end of the bellows part 111 has been described in the above-described Embodiments 2 and 3, instead of this, the diameter of a second part 113 of the bellows part 111 may be reduced, and the diameter-reduced second part may be formed as the axial deviation regulating portion 115.

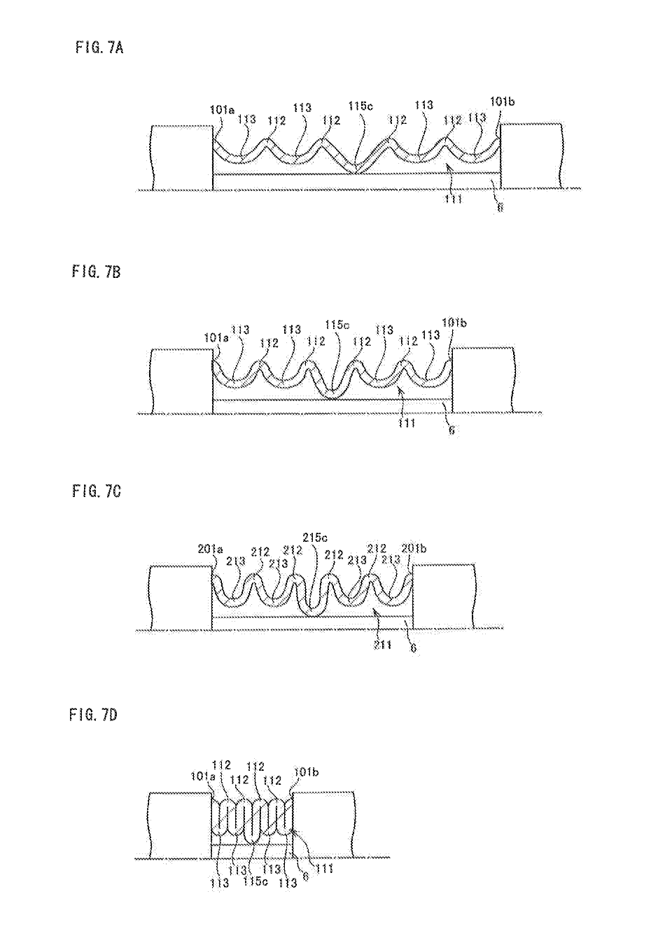

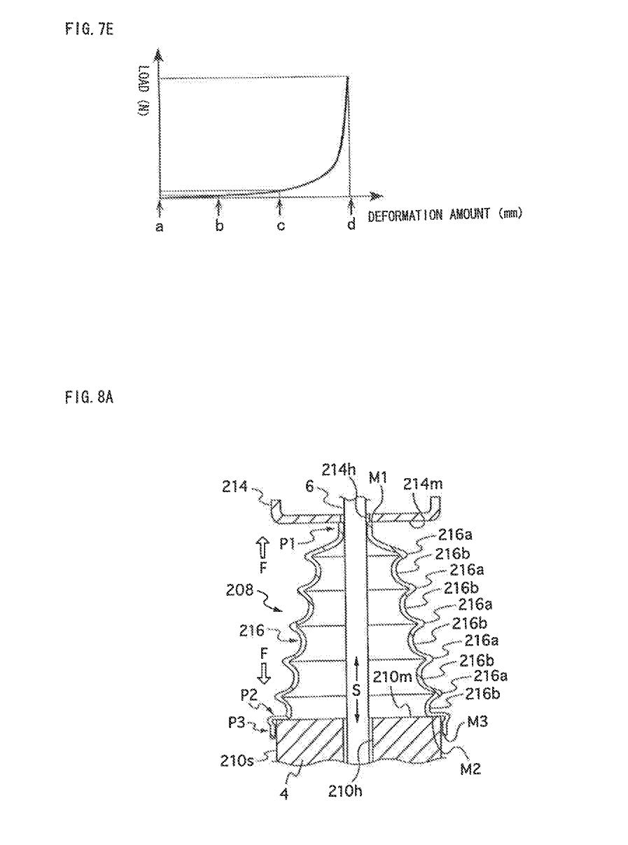

For example, in the bump stopper 1 of the present embodiment, as shown in FIGS. 7A to 7D, one second part 113, which is disposed in the middle among the first parts 112 and the second parts 113 which are alternately and repeatedly constructed along the stroke direction S, is formed by being reduced in diameter in the central direction so as to come into sliding contact with the piston rod 6, thereby constituting an axial deviation regulating portion 115c.

In a case where a second part 113 forms the axial deviation regulating portion 115b in this way, when the bellows part 111 has expanded and contracted elastically in the stroke direction S, the axial deviation regulating portion 115a moves without deviating from the stroke direction S along the piston rod 6 while being guided by the piston rod 6, i.e., without deviating axially.

In addition, since other constituent elements are the same as those of the bump stopper 101 according to the above-described Embodiment 2, the description thereof is omitted.

Here, a test result evaluated for the effects of the bump stopper 101 of the above-described Embodiments 2 to 4 and Embodiment 5 will be described. In addition, in this evaluation test, the bump stopper 101 described in the above Embodiment 5 was used.

In the evaluation test, as for an initial state (unloaded state) (FIG. 7A) where the bump stopper 101 of the invention is not compressed, for example, a first state (FIG. 7B) where the bump stopper has been gradually compressed, for example, a second state (FIG. 7C) where the bump stopper has been further compressed, and for example, a third state (FIG. 7D) where the bump stopper has been most compressed, the compressed state (deformed state: deformation amount) of the bump stopper 101 and the load at the time of compression in the individual states were evaluated by contrasting with the deformation amount-load characteristics (FIG. 7E) of a conventional product (existing product).

According to this, it can be seen that the compression-load characteristics of the bump stopper 101 of the invention are almost the same as those of the conventional product, at point a (initial state), point b (first state), point c (second state), and point d (third state) in FIG. 7E. Moreover, it can be seen that the bump stopper 101 deforms elastically without deviating from the stroke direction S of the piston rod 6, i.e., without deviating axially from the above initial state to the third state.

Thereby, it was confirmed that the bump stopper 101 of the invention is prevented from wobbling with respect to the stroke direction S of the shock absorber at the time of elastic deformation, and has the same performance (for example, shock-absorbing characteristics) as a conventional product.

### Embodiment 6

Next, a bump stopper according to Embodiment 6 will be described.

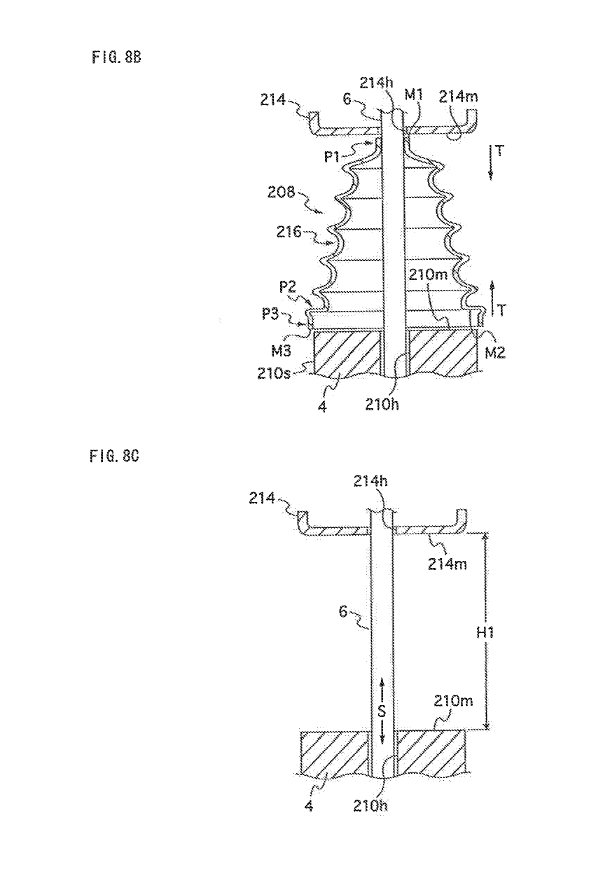

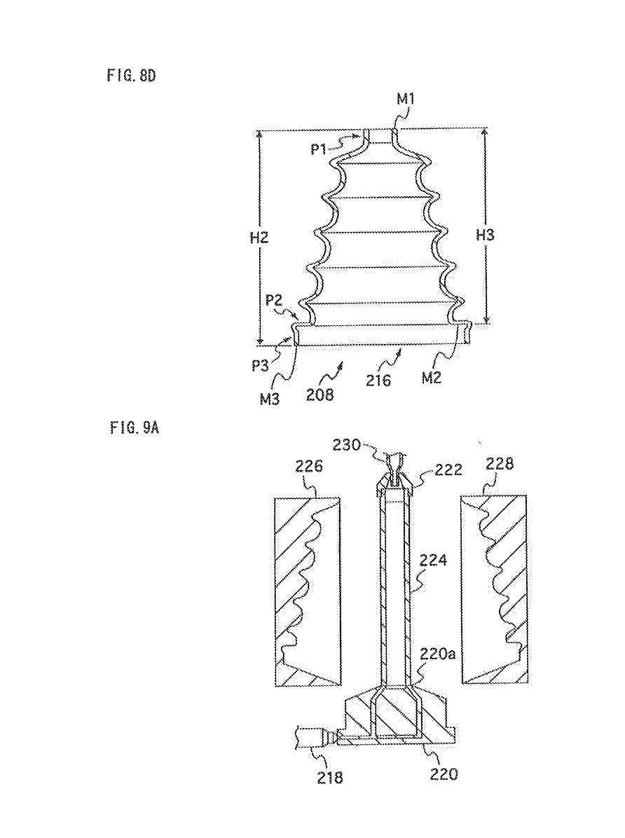

As shown in FIG. 8A, a bump stopper 208 of the present embodiment is provided at, for example, a shock absorber which absorbs the shock from the road surface during traveling of a vehicle, and when the shock absorber retracts along the stroke direction S, the bump stopper is constructed so as to limit the stroke of the shock absorber elastically and absorb the shock generated at that time.

Here, the shock absorber is constructed to include the cylindrical cylinder body (body portion) 4, and the piston rod 6 (also referred to as a cylinder rod or a shaft) which is supported so as to be capable of advancing and retreating (protruding and retracting) along the stroke direction S with respect to the cylinder body 4. In this case, the piston rod 6 is supported in an extendable and retractable manner by mating members arranged on both sides in the stroke direction S. In addition, in the following description, for example, a supporting member 14 which supports the piston rod 6 in a vibration-proof manner on the side of a vehicle body is assumed as one mating member, and for example, the cylinder body 4 is assumed as the other mating member.

According to this construction, when a load (for example, a force including shock, vibration, or the like from the road surface) has acted on the suspension during traveling of a vehicle, the piston rod 6 extends and retracts (strokes) along the stroke direction S relative to the cylinder body 4 according to the magnitude of the load, so that the load which has acted can be absorbed and the movement of the suspension can be attenuated (shock-absorbed).

The bump stopper 208 provided in such a shock absorber includes a hollow cylindrical bellows part 216 which extends along the stroke direction S of the shock absorber and which is elastically expandable and contractible along the stroke direction S. In addition, the construction of the bellows part 216 can be arbitrarily set if the bellows part can be constructed as an elastic body which is elastically expandable and contractible. In addition, “expandable and contractible” means that the bellows part 216 deforms elastically and contracts in the stroke direction S according to a load, and on the contrary, the bellows part 216 expands by its own elastic restoring force (elastic force) as the load is released.

As one construction example, the bellows part 216 shown in FIG. 8A is constructed such that first parts 216a which are molded by thinning thermoplastic resin and are bulged in a direction (radiation direction) opposite to a central direction, and second parts 216b which are recessed in the central direction are alternately provided along the stroke direction S of the shock absorber (the stroke direction S of the piston rod 6). More specifically, the first parts 216a are molded in their entirety by being bulged in the shape of a circular arc along the stroke direction S, and on the other hand, the second parts 216b are molded in their entirety by being recessed in the shape of a circular arc along the stroke direction S.

In addition, as an example in the drawing, the radius of curvature of the whole first parts 216a in the stroke direction S is set to be smaller than the radius of curvature of the whole second parts 216b in the stroke direction S. However, since the value of the magnitude of each radius of curvature is set to an optimal value according to, for example, the intended use or usage environment of the bump stopper 208, the numerical values are not particularly limited here. Additionally, since the number of first parts 216a and second parts 216b to be arranged is arbitrarily set according to, for example, the size or shape of the shock absorber to which the bump stopper 208 is applied, the numerical values are not particularly limited here.

Moreover, although the radial dimensions or thicknesses of the first parts 216a and the second parts 216b which constitute the bellows part 216 and the intervals (pitches) thereof in the stroke direction S are constantly set as an example in the drawing, the radial dimensions, thicknesses, and intervals (pitches) are arbitrarily set according to, for example, the magnitude of an elastic force, elastic characteristics, or the like to be given to the bump stopper 208 (bellows part 216). Therefore, the numerical values are not particularly limited here.

Additionally, although the specifications (for example, the radii of curvature, radial dimensions, intervals, or the like) of the above first parts 216a and the second parts 216b are set as an example in the drawing such that the overall shape (contour shape) of the bump stopper 208 (bellows part 216) is conical, the invention is not limited thereto. The middle portion of the bump stopper 208 (bellows part 216) may be recessed more than other portions, or the overall shape of the bump stopper 208 (bellows part 216) may be substantially cylindrical. In this case, since the overall shape of the bump stopper 208 (bellows part 216) is arbitrarily set according to, for example, the space or peripheral construction on the side of the shock absorber in which the bump stopper 208 is provided, the overall shape of the bump stopper (bellows part) is not particularly limited here.

Moreover, as a thermoplastic resin for manufacturing the bump stopper 208, it is possible to apply a polyester-based thermoplastic elastomer. In addition, as thermoplastic resins other than this, for example, simple substances of an olefin-based elastomer, a urethane-based thermoplastic elastomer, and a polyamide-based elastomer or mixed alloy resins of the simple substances with other thermoplastic resins may be applied.

In the present embodiment, the above bump stopper 208 is adapted to be assembled between mating members which support the piston rod 6 of the shock absorber in an extendable and retractable manner on both sides in the stroke direction S when the bellows part 216 contracts due to elastic deformation in the stroke direction S. Also, in the assembled state, first and second annular ends P1 and P2 provided at both ends of the bellows parts are elastically brought into pressure contact with the mating members, and are supported by the elastic force (restoring force) of the bellows part 216 itself.

Here, a case where the first annular end P1 (at the upper end in FIG. 8A) provided at one side of the bellows part 216 is brought into pressure contact with and supported by a supporting member 214 provided at the tip of the piston rod 6 which is one mating member and the second annular end P2 (lower end in FIG. 8A) provided at the other end of the bellows part 216 is brought into pressure contact with and supported by the cylinder body 4 which is the other mating member is assumed as an example here. In this case, the construction of the first end P1 and the second end P2 of the bump stopper 208 is arbitrarily set according to the construction of the mating members which are elastically brought into pressure contact, respectively.

As one example, in the drawing, the supporting member 214 which is one mating member is constructed such that a pressure-contacted surface 214m (surface which faces the cylinder body 4 and is brought into pressure contact with the first end P1) thereof has a substantially flat shape, and the cylinder body 4 which is the other mating member is constructed such that a pressure-contacted surface 210m (surface which faces the supporting member 214 and is brought into pressure contact with the second end P2) thereof has a substantially flat shape.

According to this construction, the first end P1 is constructed such that a pressure-contacting surface M1 (peripheral end surface brought into pressure contact with the pressure-contacted surface 214m of the supporting member 14) thereof has a substantially flat shape and the second end P2 is constructed such that a pressure-contacting surface M2 (peripheral end surface brought into pressure contact with the pressure-contacted surface 210m of the cylinder body 4) thereof has a substantially flat shape.

According to this construction, the bump stopper 208 is maintained in a state where the pressure-contacting surface M1 is brought into pressure contact with the pressure-contacted surface 214m of the supporting member 214 so as to come into close contact therewith in a surface contact manner, and the pressure-contacting surface M2 is brought into pressure contact with the pressure-contacted surface 210m of the cylinder body 4 so as to come into close contact therewith in a surface contact manner. At this time, the bellows part 216 is maintained in a state where the first and second ends P1 and P2 of the bump stopper 208 are sandwiched between the above mating members 214 and 4 by its elastic force (restoring force), in other words, in a state where the first and second ends P1 and P2 stretch the above mating members 214 and 4 with a predetermined pressure-contact force F. Thereby, the bellows part 216 is robustly and firmly fixed in a state where the first and second ends P1 and P2 are elastically brought into pressure contact with the mating members 214 and 4 stably without wobbling.

Here, the pressure-contact force F when the first and second ends P1 and P2 of the bump stopper 8 are brought into pressure contact with the above mating members 214 and 4 corresponds to the magnitude of the restoring force (elastic force) stored in the bellows part 216 itself when the bellows part 216 serving as an elastic body is contracted. Accordingly, in order to bring the first and second ends P1 and P2 of the bump stopper 8 into pressure contact with the above mating members 214 and 4 with a desired pressure-contact force F, it is preferable to assemble the above mating member 214 and 4 to each other in a state where the bellows part 216 is contracted by a predetermined amount correspondingly.

Meanwhile, the piston rod 6 of the shock absorber extends and retracts (strokes) along the stroke direction S within maximum and minimum ranges of the stroke of the piston rod relative to the cylinder body 4 according to, for example, the degree of shock from the road surface during traveling of a vehicle. For this reason, even in a case where the stroke length of the shock absorber reaches its maximum, it is necessary to maintain a state where the first and second ends P1 and P2 of the bump stopper 208 are brought into pressure contact with the above mating members 214 and 4. In this case, if the bump stopper 208 longer than the maximum stroke length is prepared and the bellows part 216 is contracted to assemble the above mating members 214 and 4 to each other, it is possible to maintain a state where the first and second ends P1 and P2 of the bump stopper 208 is always brought into pressure contact with the above mating members 214 and 4 with the desired pressure-contact force F regardless of the above stroke length of the shock absorber.

More specifically, a state where the shock absorber has extended to the maximum stroke length H1 is illustrated in FIG. 8C. The maximum stroke length H1 at this time can be specified by that between the above mating members 214 and 4 which support the piston rod 6 in an extendable and retractable manner on both sides in the stroke direction S. In more detail, the maximum stroke length H1 is specified as a length H1 along the stroke direction S between the pressure-contacted surface 214m of the supporting member 214 which is one mating member and the pressure-contacted surface 210m of the cylinder body 4 which is the other mating member.

Additionally, the construction of the bump stopper 208 molded so as to be longer along the stroke direction S than the above-described maximum stroke length H1 is illustrated in FIG. 8D. In addition, as an example in the drawing, the bump stopper 208 is provided with a hollow annular portion P3 (may also be referred to as the second end P2 as a generic term including this annular portion P3) which is continuous from the second end P2 and is capable of fitting along an outer peripheral surface 210s of the cylinder body 4. Then, the length H2 of the bump stopper 208 along the stroke direction S is specified as the length H2 along the stroke direction S between the pressure-contacting surface M1 of the first end P1 and a lower end surface M3 of the annular portion P3. In this case, the length H2 of the bump stopper 208 along the stroke direction S becomes the natural length H2 in an unloaded state where the load in the stroke direction S is not acting on the bump stopper 208.

From this state, the bellows part 216 of the bump stopper 208 with the natural length H2 is contracted by a predetermined amount along the stroke direction S. At this time, as the degree that the bellows part 216 is contracted, the bellows part 216 may be contracted in the stroke direction S to such a degree that the length (i.e., a length along the stroke direction S between the pressure-contacting surface M1 of the first end P1 and the lower end surface M3 of the annular portion P3) of the bump stopper 208 falls below at least the maximum stroke length H1 of the shock absorber. In other words, as the degree that the bellows part 216 is contracted, the bellows part 216 in the stroke direction S may be contracted to such a degree that at least the difference (H2−H1) between the maximum stroke length H1 of the shock absorber and the natural length H2 of the bump stopper 208 is exceeded.

Additionally, a state where the bump stopper 208 in which the bellows part 216 has been contracted in the stroke direction S is provided at a shock absorber, i.e., a state where the bump stopper 208 is assembled between the mating members 214 and 4 is shown in FIG. 8B. At this time, the bellows part 216 of the bump stopper 208 contracts in the stroke direction S, the pressure-contacting surface M1 of the first end P1 is in the state of being separated in the direction of an arrow T from the pressure-contacted surface 214m of the supporting member 214 which is one mating member, and the lower end surface M3 of the annular portion P3 is in the state of being separated from the pressure-contacted surface 210m of the cylinder body 4. For this reason, the pressure-contacting surface M2 of the second end P2 of the bump stopper 208 is in the state of being separated in the direction of the arrow T from the pressure-contacted surface 210m of the cylinder body 4 which is the other mating member.

In this state, if the contractive force which has acted on the bellows part 216 is released, the bellows part 216 expands due to its own restoring force (elastic force), and the first and second ends P1 and P2 of the bump stopper 208 are elastically brought into pressure contact with the above mating members 214 and 4. Specifically, the first end P1 is brought into pressure contact with the supporting member 214 which is one mating member, and simultaneously, the second end P2 is brought into pressure contact with the cylinder body 4 which is the other mating member. In this case, the bump stopper 208 is maintained in a state where the pressure-contacting surface M1 is brought into pressure contact with the pressure-contacted surface 214m of the supporting member 214 so as to come into close contact therewith in a surface contact manner, and the pressure-contacting surface M2 is brought into pressure contact with the pressure-contacted surface 210m of the cylinder body 4 so as to come into close contact therewith in a surface contact manner.

At this time, the bump stopper 208 is maintained in a state where the first and second ends P1 and P2 of the bump stopper 208 are sandwiched between the above mating members 214 and 4 by the elastic force (restoring force) of the bellows part 216 (a state where the first and second ends P1 and P2 stretch the above mating members 214 and 4 with a predetermined pressure-contact force F). Thereby, as shown in FIG. 8A, the bump stopper 208 is robustly and firmly supported in a state where the first and second ends P1 and P2 are elastically brought into pressure contact with the mating members 214 and 4 stably without wobbling.

If the pressure-contact force F in a state where the first and second ends P1 and P2 of the bump stopper 208 are brought into pressure contact with the above mating members 214 and 4 (FIG. 8A) after the above assembling process is finished is taken into consideration, the magnitude of the pressure-contact force F has the capacity which corresponds to (coincides with) the elastic force (restoring force) stored in the bellows part 216 itself. In this case, in a state where the first and second ends P1 and P2 are brought into pressure contact with the above mating members 214 and 4, the bump stopper 208 is maintained in a state where the length along the stroke direction S has reduced by the above difference (H2-H1) between the maximum stroke length H1 of the shock absorber and the natural length H2 of the bellows part 216.

Generally, it is known that the elastic force (restoring force) of an elastic body changes so as to increase and decrease in proportion to the contraction amount of the elastic body. Then, as shown in FIG. 8A, the elastic force (restoring force) proportional to the contraction amount which has reduced by the above difference (H2-H1) between the maximum stroke length H1 of the shock absorber and the natural length H2 of the bump stopper 208 is stored in the bump stopper 208 (bellows part 216) in a state where the first and second ends P1 and P2 are brought into pressure contact with the above mating members 214 and 4. Also, the bump stopper 208 is supported by the elastic force (restoring force) stored at this time such that the first and second ends P1 and P2 are brought into pressure contact with the above mating members 214 and 4 with a pressure-contact force F.

Accordingly, by setting arbitrarily the above difference (H2-H1) between the maximum stroke length H1 of the shock absorber and the natural length H2 of the bump stopper 208, it is possible to adjust arbitrarily the elastic force (restoring force) to be stored in the bump stopper 208 (bellows part 216) itself. As a result, the pressure-contact force F of the bump stopper 208 (first and second ends P1 and P2) with respect to the above mating members 214 and 4 can be arbitrarily changed so as to increase and decrease. Thereby, simply by setting arbitrarily the above difference (H2−H1) between the maximum stroke length H1 of the shock absorber and the natural length H2 of the bump stopper 208, the bump stopper 208 can be provided at the shock absorber, i.e., can be assembled between the above mating members 214 and 4 in a state where the first and second ends P1 and P2 are brought into pressure contact with the above mating members 214 and 4 with an optimal pressure-contact force F according to, for example, the intended use or usage environment of the shock absorber.

Here, a method for manufacturing the bump stopper 208 having the above bellows part 216 will be described. Here, a press-blow molding method is assumed as an example of the manufacturing method.

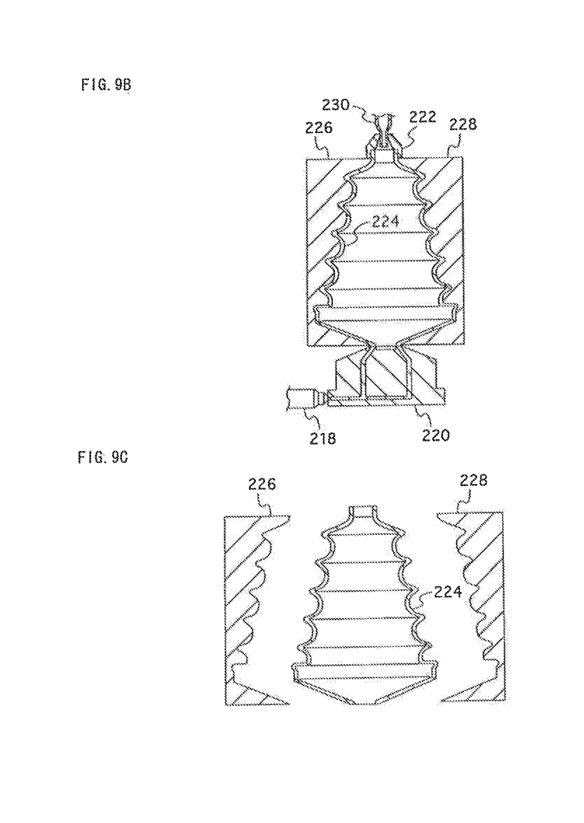

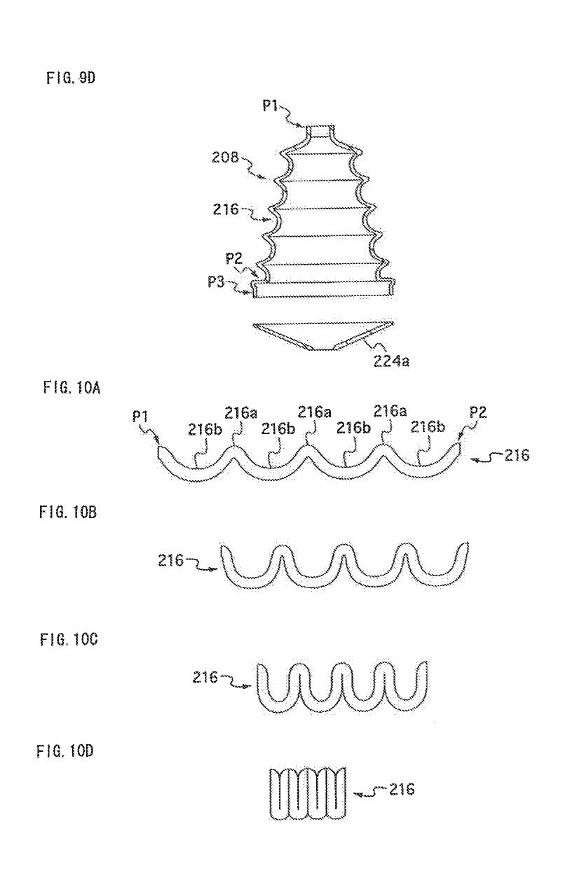

First, as shown in FIG. 9A, an initial molding process is performed. At this time, a melted thermoplastic resin material which has been extruded to the die 220 from the extruder 218 passes through an extrusion port 220a which is open annularly toward an upper portion of the die 220. Thereafter, the resin material is supplied to and held by the pull-up member 222 and is molded in a predetermined shape.

Next, pull-up processing of the pull-up member 222 is performed. At this time, the thickness of the parison 224 is controlled while adjusting the pull-up speed of the pull-up member 222 and the extrusion amount of thermoplastic resin material. Thereby, the parison 224 is pulled up between the split mold tools 226 and 228 in a state which the parison is continuous in a tubular shape without interruption. In addition, the mutual inner surfaces of the mold tools 226 and 228 are formed with an undulating shape along the external contour of the bellows part 216.

Subsequently, as shown in FIG. 9B, blow molding process is performed after both the mold tools 226 and 228 are clamped together. At this time, compressed gas (for example, air) is injected toward the inside of the parison 224 from a blow nozzle 230 provided in the pull-up member 222. Thereby, the parison 224 expands in the radial direction and comes into close contact with the mutual inner surfaces of the mold tools 226 and 228, the undulating shape formed at the mutual inner surfaces of the mold tools 226 and 228 is transferred to the parison 224, and thereby a part corresponding to the thinned bellows part 216 (FIG. 8A) is molded. Thereafter, by cooling the mold tools 226 and 228 to cure thermoplastic resin material, the parison 224 which comes in close contact with the mutual inner surfaces of the mold tools 226 and 228 is stabilized in the shape of the bellows part 216.

Thereafter, as shown in FIG. 9C, the mold tools 226 and 228 are separated from each other and a molded product obtained by curing the parison 224 is removed. Then, as shown in FIG. 9D, a surplus portion 224a is cut off from the molded product. Thereby, as shown in FIG. 8D, the bump stopper 208 having the thinned bellows part 216 of the natural length H2 can be finished.

In addition, as an example, the method of performing the clamping processing between the mold tools 226 and 228 after the parison 224 is formed has been described here. Instead of this, after the clamping processing between the mold tools 226 and 228 is performed in advance, the bump stopper 208 having the above bellows part 216 of the natural length H2 may be manufactured by the method of setting a tubularly continuous parison 224.

As described above, according to the present embodiment, the first and second ends P1 and P2 are elastically fixed in pressure contact with the above mating members 214 and 4 by the elastic force (restoring force) of the bellows part 216 itself of the bump stopper 208. Thereby, when a load acts on the suspension during traveling of a vehicle, and the piston rod 6 of the shock absorber expands and contracts (strokes) relative to the cylinder body 4, the bellows part 216 expands and contracts so as to follow the expansion and contraction, so that the bump stopper 208 which can absorb the load which has acted and attenuate (shock-absorb) the movement of the suspension can be realized.

According to this, since the bellows part 216 can attenuate (shock-absorb) the movement of the suspension while always following the stroke of the piston rod 6, the bellows part 216 makes a compressive elastic deformation continuously and flexibly without causing the above striking bottom(bump touch) phenomenon of the shock absorber, so that the load which has acted on the suspension can be continuously and flexibly absorbed. As a result, generation of the impact noise or vibration at the time of a bump touch which was conventionally generated can be prevented and can be completely suppressed.

That is, such generation of the impact noise or vibration at the time of a bump touch could not be prevented by, for example, an existing shock-absorbing member called a bump rubber, a jounce bumper, or the like. In the present embodiment, however, when the bellows part 216 makes a compressive elastic deformation flexibly and continuously, generation of the impact noise or vibration at the time of a bump touch which was conventionally generated can be prevented and can be completely suppressed. Thereby, since the above impact noise or vibration does not continue propagating repeatedly into a vehicle during traveling of the vehicle unlike the conventional technique, passenger's riding comfort or calmness in the vehicle during traveling of a vehicle can be markedly improved.

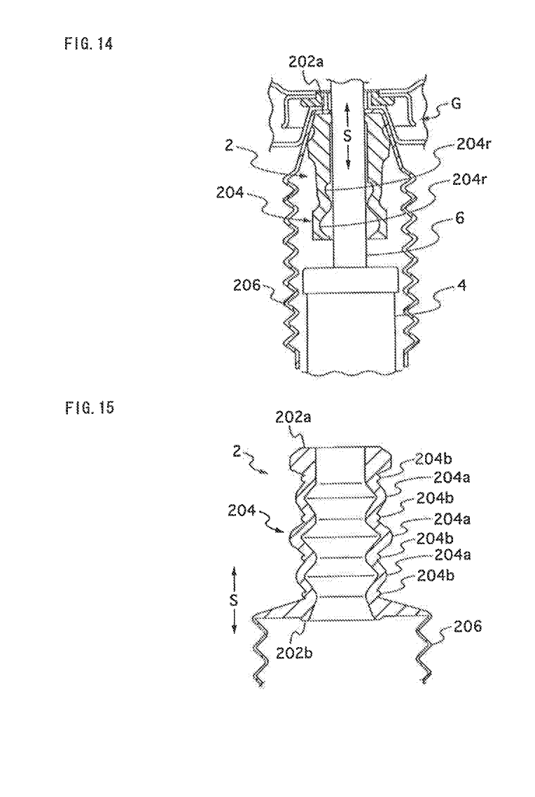

Additionally, according to the present embodiment, simply by contracting the bellows part 216 of the bump stopper 208 and assembling the bellows part between the above mating members 214 and 4 like the assembling process (FIGS. 8B to 8D) and releasing the contractive force, without necessitating robustly and firmly fixing one end 202a of the bump stopper to a mating member by an attachment mechanism unlike the conventional bump stopper 2 shown in FIG. 14, the bellows part 216 of the bump stopper 208 can be robustly and firmly fixed by the elastic force (restoring force) in a state where the first and second ends P1 and P2 are brought into pressure contact with the above mating members 214 and 4 with a desired pressure-contact force F. For this reason, compared to the conventional technique, the bump stopper 208 can be easily assembled to a shock absorber without taking substantial effort or time. Additionally, it is also possible to omit a fixing member for fixing the first end P1 of the bump stopper 208 to a predetermined part.

Moreover, in the assembling process of the present embodiment, the contractive force has simply to be released after the bellows part 216 is once contracted. Therefore, anyone can perform the assembling process easily and definitely without taking skill. Thereby, since the bump stopper 208 can be efficiently (for example, simply in a short time) assembled to a shock absorber without using special attachment fittings, the assembling performance of the bump stopper 208 into the shock absorber can be markedly improved, and the low cost by reduction of attachment fittings can be realized.

Additionally, according to the present embodiment, the bump stopper 208 having the bellows part 216 which is integrally molded from thermoplastic resin can be realized. In this case, since thermoplastic resin has material characteristics which are excellent in durability and water resistance unlike urethane foam resin, the bump stopper 208 itself made of thermoplastic resin can also serve as a dust cover. For this reason, there is no necessity for arranging a dust cover (not shown) separately so as to cover the entire bump stopper 208. Thereby, since there is no necessity for securing, for example, the arrangement space for a dust cover around the shock absorber, and the number of parts can also be reduced that much, it is possible to sufficiently meet the request for miniaturization or low costs.

According to such a bump stopper 208, it is possible to simultaneously cover an insertion hole 210h (FIGS. 8A and 8B) of the piston rod 6 formed at an end surface of the cylinder body 4 of the shock absorber, and an insertion hole 214h (FIGS. 8A and 8B) of the piston rod 6 formed in the supporting member 214 which supports the piston rod 6 in a vibration-proof manner on the side of a vehicle body. For this reason, entry of foreign matter, such as dust, can be prevented without separately providing a dust cover unlike the conventional technique.

In addition, in a case where the insertion hole 214h of the piston rod 6 formed in the supporting member 214 is blocked by insertion of the piston rod 6 (in a case where a gap is not formed between the piston rod 6 and the insertion hole 214h), the first end P1 of the bump stopper 208 may not have the structure in which the insertion hole 214h of the piston rod 6 is covered.

Additionally, according to the method for manufacturing the bump stopper 208 having the above bellows part 216 made of thermoplastic resin, as shown in FIGS. 9A to 9D, the bump stopper 208 (the bellows part 216, the first and second ends P1 and P2, and the annular portion P3) and individual constituent elements can be simultaneously molded in a lump by a series of press-blow molding methods. In this case, the molding process of the dust cover 206 different from the molding process of the bellows part 204 becomes unnecessary unlike the conventional bump stopper 2 shown in FIG. 15. For this reason, in the manufacturing method of the present embodiment, the molding process is simplified compared to the conventional technique, and substantial effort or time is not taken. Therefore, the manufacturing efficiency of the bump stopper 208 can be markedly improved, and manufacturing costs can be significantly reduced.

Moreover, according to the present embodiment, the bump stopper 208 having the whole bellows part 216 which is integrally molded by thinning thermoplastic resin can be realized. In this case, for example, compared to a weight obtained by adding the weight of the dust cover 206 to the weight of the conventional bump stopper 2 which is molded by thickening urethane foam resin shown in FIG. 14 and compared to the weight of the conventional bump stopper 2 with an integral dust cover 206 type shown in FIG. 15, it is possible to reduce the weight of the bump stopper 208. Moreover, compared to the bellows part 204 of the above-described conventional bump stopper 2, it is also possible to suppress the amount of the resin material to be used for manufacturing the bellows part 216 of the bump stopper 208, thereby keeping down the manufacturing costs of a bump stopper 208.

Additionally, according to the present embodiment, in the series of press-blow molding methods as shown in FIGS. 9A to 9D, the bellows part 216 with desired shape and thickness can be molded only by blow-molding the parison 224 made of thermoplastic resin. Thereby, a molding cycle can be extremely shortened compared to the conventional technique. Additionally, since a so-called solid bellows part 216 can be realized by using the thermoplastic resin as a molding material, the dimensional precision of the bump stopper 208 serving as a finished product can be maintained constantly.

Additionally, the above thermoplastic resin has material characteristics capable of maintaining the durability thereof constantly under a wide range of temperature environments from a high temperature to a low temperature. For this reason, even if a vehicle to which the bump stopper 208 having the bellows part 216 made of thermoplastic resin is applied is used in, for example, a cold region, the shock-absorbing characteristics of the bump stopper 208 (bellows part 216) can be maintained constantly for a prolonged period of time, and damage of the bump stopper 208 (bellows part 216) can be prevented even if the vehicle is used under an extremely low temperature.

Moreover, the above thermoplastic resin has material characteristics which have an excellent water resistance without being hydrolyzed. For this reason, in a case where a vehicle using the bump stopper 208 having the bellows part 216 made of thermoplastic resin is used, for example, in a humid area with a lot of rain, or even in a case where the chassis of the vehicle is steam-washed, the durability performance of the bump stopper 208 (bellows part 216) can be maintained constantly for a prolonged period of time.

Moreover, the above thermoplastic resin can be reused (recycled) as a raw material for molding as is, for example, the surplus portion 224a cut off during manufacturing as shown in FIG. 9D or the used bump stopper 208 can be collected, and this can be recycled as a molding material for manufacturing a new bump stopper. Thereby, the material yield rate can be improved, and an ecological bump stopper 208 for which the global environment is also taken into consideration can be realized.

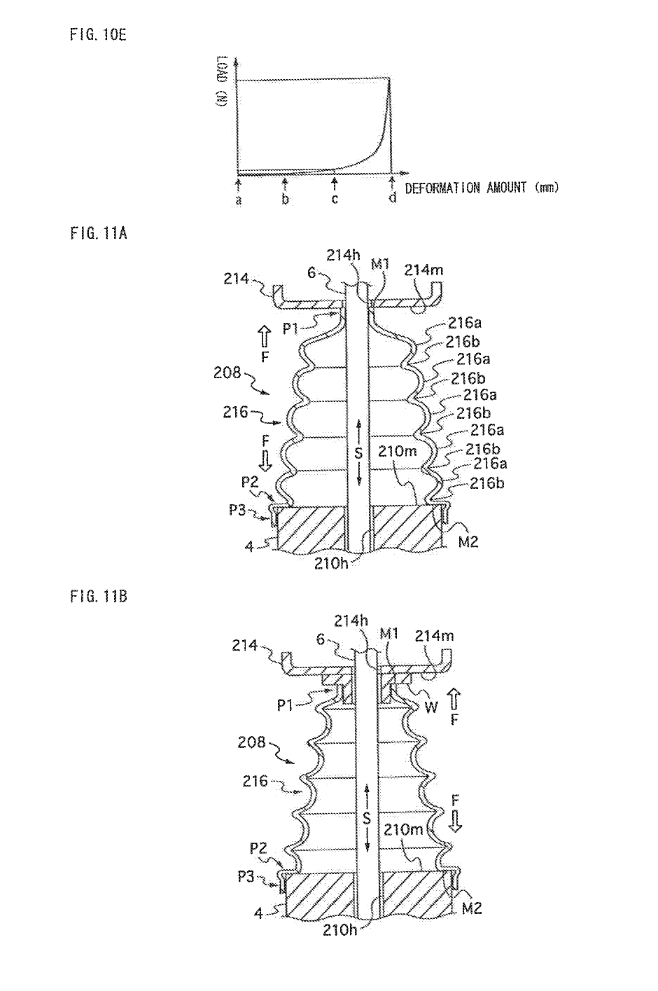

Here, a test result evaluated for the effects of the above bump stopper 208 (bellows part 216) will be described with reference to FIGS. 10A to 10E.

In the evaluation test, as for an unloaded initial state (FIG. 10A) where the bump stopper 208 (bellows part 216) is not compressed, a first state (FIG. 10B) where the bump stopper has been gradually compressed, a second state (FIG. 10C) where the bump stopper has been further compressed, and for example, a third state (FIG. 10D) where the bump stopper has been most compressed, the relationship between the deformation amount of the bump stopper 208 (bellows part 216) and the load in the individual states were evaluated by contrasting with the deformation amount-load characteristics (FIG. 10E) of a conventional product (existing product).

According to this, as shown in FIG. 10E, it can be seen that the compression-load characteristics of the above bump stopper 208 (bellows part 216) are almost the same as the characteristics of the conventional product, at point a (initial state), point b (first state), point c (second state), and point d (third state). Thereby, it was confirmed that the above bump stopper 208 (bellows part 216) has the same performance (for example, shock-absorbing characteristics) as that of a conventional product.

In addition, the operation and effects of the above embodiment can be similarly realized, for example, even in the bump stopper 208 (bellows part 216) shown in FIGS. 11A and 11B.

A bellows part 208 related to a modification shown in FIG. 11A is constructed such that first parts 216a which are bulged in a direction (radiation direction) opposite to a central direction, and second parts 216b which are recessed in the central direction are reversed with respect to the construction of the bellows part 216 shown in FIG. 8A.

In a bump stopper 208 related to another modification shown in FIG. 11B, the first end P1 is not directly brought into pressure contact with the supporting member 214, but is brought into pressure contact with a pressure-contacting structure W provided at the supporting member 214. In this case, since the pressure-contacting structure W is not limited to the shape shown in the drawing and is set to an arbitrary shape according to the intended use thereof, the first shape, size, or the like of the first end P1 of the bump stopper 208 may be set correspondingly.

Additionally, in the above embodiment, when the bellows part 216 expands and contracts elastically along the stroke direction S (FIG. 8A), air-pressure adjusting mechanisms which keep the air pressure within the bump stopper 208 constant may be provided, for example, at the first and second ends P1 and P2 to construct the bump stopper 208. Each air-pressure adjusting mechanism includes a communication passage which enables outflow and inflow of air between the inside and outside of the bump stopper 208 when the bellows part 216 expands and contracts along the stroke direction S. In this case, since a case where a shock absorber is used in an environment where the shock absorber is exposed to the water which has rebounded from the road surface during traveling of a vehicle is assumed, it is preferable that the communication passage has the structure in which entry of the water into the inside of the bump stopper 208 is regulated.

Here, although the communication passage of the air-pressure adjusting mechanism may be provided at least in one part of the bump stopper 208, communication passages formed in the first end P1 are shown as an example in FIG. 12A. In addition, the bellows part 216 has a shape tapered toward the first end P1, and the first end P1 has a hollow cylindrical shape capable of fitting along the outer periphery of the piston rod 6 (FIG. 8A).

In this case, the first end P1 of the bump stopper 208 is provided with opening grooves 232 which are formed by being locally recessed so as to cross the pressure-contacting surface M1, and guide grooves 234 formed toward the inside of the bellows part 216 continuously along the inner peripheral surface of the first end P1 from the opening grooves 232, and one communication passage which communicates from the inside of the bump stopper 208 (bellows part 216) to the outside of the bump stopper 208 (bellows part 216) is constructed via the guide grooves 234 from the opening grooves 232.

In addition, the size (for example, width or groove depth) of the communication passages which are constructed via the guide grooves 234 from the opening grooves 232 is arbitrarily set according to the shape or size of the first end P1 of the bump stopper 208. Therefore, although the size of the communication passages is not particularly limited here, foreign matter (for example, water or dust) from the outside may enter the bellows part 216 easily, particularly if the opening grooves 232 are set to be considerably large. Therefore, in consideration of this, it is preferable to set the size of the communication passages to be comparatively small. By doing so, entry of water into the inside of the bump stopper 208 (bellows part 216) can be regulated.

Additionally, in the drawing, a plurality of communication passages which is constructed via the guide grooves 234 from the opening grooves 232 is provided at predetermined intervals in the circumferential direction along the first end P1 of the bump stopper 208. However, since the number of communication passages is arbitrarily set according to the shape or size of the first end P1 of the bump stopper 208, the number of communication passages is not particularly limited here. In addition, although communication passages having a substantially rectangular shape are shown in the drawing, the shape of the communication passages is not limited thereto, and can be various kinds of shapes, such as a circular arc shape, a triangular shape, and an elliptical shape.

According to this construction, when the bellows part 216 expands and contracts elastically along the stroke direction S, outflow and inflow of air are performed between the inside and outside of the bump stopper 208 (bellows part 216) via the communication passages. Therefore, the air pressure within the bump stopper 208 (bellows part 216) can be kept constant. In other words, the pressure differential between the air pressure within the bump stopper 208 (bellows part 216) and the air pressure outside the bump stopper 208 (bellows part 216) can be eliminated. Then, since action of superfluous air pressure on the bellows part 216 can be eliminated, targeted spring characteristics can be obtained without pressurizing the inside of the bellows part 216 at the time of the compression thereof and without affecting the spring characteristics of the bellows part 216. Additionally, since an extra pressure change is not given to the bellows part 216, it is possible to prevent premature deterioration of the bellows part 216.

Additionally, as a method of molding the above communication passages (the opening grooves 232 and the guide grooves 234) at the first end P1 of the bump stopper 208, for example, the communication passages can be molded in a lump in the initial molding process, by giving the structure for molding the above communication passages (the opening grooves 232 and the guide grooves 234) inside the pull-up member 222 used for the initial molding process of FIG. 9A. Thereby, the bump stopper 208 in which the above communication passages (the opening grooves 232 and the guide grooves 234) are integrally molded in the first end P1 can be finished.

According to this, the manufacturing method (FIGS. 9A to 9D) of the bump stopper 208 in the above embodiment is available as is, and the bump stopper 208 in which the above communication passages (the opening grooves 232 and the guide grooves 234) are integrally molded in the first end P1 can be finished without requiring the separate processing for molding the above communication passages (the opening grooves 232 and the guide grooves 234). For this reason, the low-cost bump stopper 208 which is excellent in manufacturing efficiency can be provided.

Additionally, communication passages formed in the second end P2 of the bump stopper 208 are shown as an example in FIG. 12B. In this case, the bump stopper 208 is constructed such that the second end P2 (specifically, the annular portion P3 included in the second end P2) has a hollow cylindrical shape capable of fitting along an outer peripheral surface 210s of the cylinder body 4.

In this construction, the annular portion P3 of the bump stopper 208 is formed with separating portions 236 which are locally separated from the outer peripheral surface 210s of the cylinder body 4, one communication passage 238 which communicates from the inside of the bump stopper 208 (bellows part 216) to the outside of the bump stopper 208 (bellows part 216) is constructed between an inner surface 236s of each separating portion 236 and the outer peripheral surface 210s of the cylinder body 4.

In addition, since the size (for example, width or passage length) of the communication passages 238 which are constructed between the inner surfaces 236s of the separating portions 236 and the outer peripheral surface 210s of the cylinder body 4 is arbitrarily set according to the shape or size of the annular portion (P3) (second end P2) of the bump stopper 208. Therefore, although the size of the communication passages is not particularly limited here, foreign matter (for example, water or dust) from the outside may enter the bellows part 216 easily, particularly if the length of the communication passages 238 is set to be considerably short. For this reason, in consideration of this, it is preferable to set the length of the communication passages to be comparatively long. By doing so, the structure which enables the inside of the bump stopper 208 (bellows part 216) to be maintained in a watertight state is realized.

Additionally, in the drawing, a plurality of communication passages 238 which is constructed between the inner surfaces 236s of the separating portions 236 and the outer peripheral surface 210s of the cylinder body 4 is provided at predetermined intervals in the circumferential direction along the second end P2 of the bump stopper 208. However, since the number of communication passages is arbitrarily set according to the shape or size of the annular portion P3 (second end P2) of the bump stopper 208, the number of communication passages is not particularly limited here. In addition, although communication passages having a substantially rectangular shape are shown in the drawing, the shape of the communication passages is not limited thereto, and can be, for example, various kinds of shapes, such as a circular arc shape, a triangular shape, and an elliptical shape.

According to this construction, when the bellows part 216 expands and contracts elastically along the stroke direction S, outflow and inflow of air are performed between the inside and outside of the bump stopper 208 (bellows part 216) via the communication passages 238. Therefore, the air pressure within the bump stopper 208 (bellows part 216) can be kept constant. In other words, the pressure differential between the air pressure within the bump stopper 208 (bellows part 216) and the air pressure outside the bump stopper 208 (bellows part 216) can be eliminated. Then, since action of superfluous air pressure on the bump stopper 208 (bellows part 216) can be eliminated, targeted spring characteristics can be obtained without pressurizing the inside of the bump stopper 208 (bellows part 216) at the time of the compression thereof and without affecting the spring characteristics of the bellows part 216. Additionally, since an extra pressure change is not given to the bellows part 216, it is possible to prevent premature deterioration of the bellows part 216.

Additionally, as a method of molding the above communication passages 238 at the second end P2 of the bump stopper 208, for example, the structure for molding the communication passages 238 are given to the mutual inner surfaces of the mold tools 226 and 228 used for the blow molding processing of FIG. 9B, i.e., cavities along the external contour of the separating portions 236 may be given to the mutual inner surfaces of the mold tools 226 and 228. Thereby, the separating portions 236 can be molded in a lump in the blow molding process. As a result, the bump stopper 208 in which the separating portions 236 are integrally molded at the second end P2 can be finished.

According to this, the manufacturing method (FIGS. 9A to 9D) of the bump stopper 208 in the above embodiment is available as is, and the bump stopper 208 in which the separating portions 236 are integrally molded at the second end P2 can be finished without requiring the separate processing for molding the above separating portions 236. For this reason, the low-cost bump stopper 208 which is excellent in manufacturing efficiency can be provided.

In addition, although the case where the above-air-pressure adjusting mechanism is constructed at either the first end P1 of the bump stopper 208 or the second end P2 is assumed in FIGS. 12A and 12B, the invention is not limited thereto, and the above air-pressure adjusting mechanisms may be simultaneously constructed at both the first end P1 of the bump stopper 208 and the second end P2.

Additionally, in the above-described embodiment, the case where the first and second ends P1 and P2 are elastically fixed in pressure contact with the above mating members 214 and 4 by the elastic force (restoring force) of the bellows part 216 itself after assembling the bump stopper 208 to a shock absorber is assumed. Instead of this, after assembling the bump stopper 208 to a shock absorber, the bump stopper 208 may be supported between the mating members 214 and 4 in a state where the bump stopper is maintained at the natural length H2 (FIG. 8D).

In this case, as shown in FIG. 8B, as for a method of assembling the bump stopper 208 to a shock absorber, the bellows part 216 of the bump stopper 208 is contracted and assembled between the above mating members 214 and 4, and the contractive force is released. At this time, the bump stopper 208 expands to the natural length H2 in the direction of stroke S by the elastic force (restoring force) of the bellows part 216, and is brought into a state where the first and second ends P1 and P2 face the above mating members 214 and 4 without a gap. Specifically, the bump stopper is brought into a state where the pressure-contacting surface M1 of the first end P1 faces the pressure-contacted surface 214m of the supporting member 214 without a gap (or in a slightly separated state) and the pressure-contacting surface M2 of the second end P2 faces the pressure-contacted surface 210m of the cylinder body 4 without a gap (in a slightly separated state).

In order to support the bump stopper 208 between the mating members 214 and 4 in such the state, in the natural length H2 (FIG. 8D), the bump stopper 208 may be constructed such that the length H3 along the stroke direction S between the pressure-contacting surface M1 of the first end P1 and the lower end surface M3 of the second end P2 (annular portion P3) coincides with or substantially coincides with the maximum stroke length H1 (FIG. 8C) of the shock absorber.

1-7. (canceled)

8. A bump stopper provided in the vicinity of a piston rod of a shock absorber to elastically limit a stroke of the shock absorber at a time of a contraction thereof and to absorb a shock generated at that time, the bump stopper comprising:
a hollow cylindrical bellows part which extends along a stroke direction of the shock absorber,
a first annular end provided at one end of the bellows part; and
a second annular end provided at the other end of the bellows part,
wherein the bellows part is molded by thinning thermoplastic resin and is constructed such that first parts which are bulged in a direction opposite to a central direction and second parts which are recessed in the central direction are provided alternatively and repeatedly in the stroke direction of the shock absorber,
the first annular end is supported by one mating member and is brought into pressure contact with the one mating member by the elastic force of the bellows, and
the second annular end is supported by an other mating member and is brought into pressure contact with said other mating member by the elastic force of the bellows part.

9. The bump stopper according to claim 1, wherein the bump stopper is assembled between the one mating member and the other mating member.

10. The bump stopper according to claim 2, wherein the one mating member is a supporting member provided at the tip of the piston rod of the shock absorber, and the other mating member is a cylindrical body of the shock absorber.
